(19) United States
(12) Patent Application Publication
(10) Pub. No.: US 2026/0318437 A1
(43) Pub. Date: Oct. 15, 2026

(54) RUBBER VALVE TYPE OF SOLENOID VALVE

(71) Applicant: SHINWA CONTROLS CO., LTD, Kawasaki-Shi (JP)

(72) Inventors: Toshiaki TSUCHIZAWA, Kawasaki-Shi (JP); Motoharu ONO, Kawasaki-Shi (JP)

(73) Assignee: SHINWA CONTROLS CO., LTD, Kawasaki-Shi (JP)

(21) Appl. No.: 19/476,261

(22) PCT Filed: Apr. 26, 2024
(86) PCT No.: PCT/JP2024/016426

§ 371 Date: Oct. 17, 2025

(30) Foreign Application Priority Data
Apr. 27, 2023 (JP) 2023-073160

(51) Int. Cl. F16K 31/06; F16K 7/14

(52) U.S. Cl. CPC F16K 31/0672; F16K 7/14

(57) ABSTRACT

A rubber valve type of solenoid valve including: a main body having a rubber valve seating surface in which at least one flow channel is opened; a rubber valve configured to be seated on the rubber valve seating surface of the main body; a holding core having one end which holds the rubber valve; a movable core connected to the other end of the holding core; and an electromagnetic force applying part configured to apply an electromagnetic force to the movable core in order to move the movable core and the holding core with respect to the rubber valve seating surface of the main body such that the rubber valve is moved with respect to the rubber valve seating surface. The rubber valve has: an opening closure surface portion; a cylindrical portion; and a flange portion.

### TECHNICAL FIELD

The present invention relates to a rubber valve type of solenoid valve which is used for controlling a flow or a stop of a fluid, such as an ink for printing.

### BACKGROUND ART

Conventionally, a rubber valve type of solenoid valve has been used for controlling a flow or a stop of a fluid.

For example, as shown in FIG. 14, a conventional diaphragm type of solenoid valve (an example of a rubber valve type of solenoid valve) includes: a main body 110 having a diaphragm seating surface 112 in which flow channels 110a, 110b are opened; a diaphragm 123 configured to be seated on the diaphragm seating surface 112 of the main body 110; a diaphragm boss 122 holding the diaphragm 123; a movable core (not shown in FIG. 14) holding the diaphragm boss 122; and an electromagnetic force applying part (not shown in FIG. 14) configured to apply an electromagnetic force to the movable core in order to move the movable core in a direction away from the diaphragm seating surface 112 of the main body 110 such that the diaphragm 123 is released from the diaphragm seating surface 112.

In detail, the diaphragm boss 122 includes a to-be-covered main part 122m which has a large diameter and is covered by the diaphragm 123, and a small-diameter part 122e which extends upward from a center portion of the to-be-covered main part 122m. The diaphragm 123 includes: a diaphragm-boss covering part 123c which covers the to-be-covered main part 122m and a lower area of the small-diameter part 122e; a thinner part 123b which annularly extends on an outer side than the diaphragm-boss covering part 123c; and a thicker outer peripheral part 123a which annularly extends on a further outer side than the thinner part 123b.

The to-be-covered main part 122m and the lower area of the small-diameter part 122e of the diaphragm boss 122 are fitted into (and removable from) the diaphragm-boss covering part 123c of the diaphragm 123, with an aid of an elastic deformation of the diaphragm-boss covering part 123c, by a manual operation of an operator.

Herein, in the conventional diaphragm type of solenoid valve shown in FIG. 14, the thinner part 123b is utilized to cause an elastic deformation of the diaphragm 123. However, durability of the thinner part 123b may become an issue.

The applicant has developed a diaphragm type of solenoid valve in which a diaphragm boss does not drop off from a diaphragm when a movable core is moved up. Specifically, the applicant has developed a technology in which the diaphragm is integrally formed with the diaphragm boss by a baking process (JP-A-2020-076437 (Patent Document 1)).

### PRIOR ART DOCUMENT LIST

### Patent Document

[Patent Document 1] JP-A-2020-076437

### SUMMARY OF INVENTION

### Technical Problem to be Solved by Invention

In the conventional diaphragm type of solenoid valve, the deformation of the diaphragm 123 is borne by on the thinner part 123b that annularly extends on the outer side than the diaphragm-boss covering part 123c.

While studying for developing a small rubber valve type of solenoid valve, the inventors of the present invention have discovered that a rubber valve type of solenoid valve having excellent durability can be achieved by making an area bearing the deformation thereof a cylindrical area extending in a height direction, rather than an annular area having a thinner part with respect to a height direction (see the thinner part 123b in FIG. 14).

The present invention has been made based on the above findings. The object of the present invention is to provide a new configuration for a rubber valve type of solenoid valve having excellent durability.

### Solution to Problem

A first aspect of the present invention is a rubber valve type of solenoid valve including: a main body having a rubber valve seating surface in which at least one flow channel is opened; a rubber valve configured to be seated on the rubber valve seating surface of the main body; a holding core having one end which holds the rubber valve; a movable core connected to the other end of the holding core; and an electromagnetic force applying part configured to apply an electromagnetic force to the movable core in order to move the movable core and the holding core with respect to the rubber valve seating surface of the main body such that the rubber valve is moved with respect to the rubber valve seating surface; wherein the rubber valve has: an opening closure surface portion; a cylindrical portion which extends from the opening closure surface portion towards the holding core; and a flange portion which annularly extends on an outer side than an end of the cylindrical portion on a side of the holding core, an outer circumferential area of the flange portion is fixed to the main body, the opening closure surface portion is fixed to the holding core, and the cylindrical portion is not fixed to the holding core and is capable of being deformed in an extended and shortened manner with respect to the holding core.

According to the first aspect of the present invention, since the deformation of the cylindrical portion in an extended and shortened manner is utilized to cause an elastic deformation of the rubber valve, there is no need to provide any thinner part. Therefore, the issue of durability due to the existence of the thinner part can be fundamentally solved.

Specifically, the flange portion does not need to have a so-called thinner part. It is preferable that the flange portion has a thickness of 0.5 mm or more at any position from the viewpoint of durability. As second best, it is preferable that the flange portion has a thickness of 0.4 mm or more from the viewpoint of practical durability.

In addition, according to the first aspect of the present invention, since the opening closure surface portion of the rubber valve and the holding core are fixed to each other (for example, with a vulcanized adhesive or by a fitting type of fixing method), the fixing between them is stronger. That is to say, according to the present invention, the movable core to which the electromagnetic force is applied and the holding core which holds the rubber valve are separately prepared and connected to each other, and thus the rubber valve can be integrally formed with the holding core by a baking process. For example, a corresponding mold can be prepared, and the rubber valve can be formed around a predetermined portion of the holding core by a baking process, so that the opening closure surface portion of the rubber valve and the holding core can be fixed with a vulcanized adhesive during the baking process.

Herein, the phrase “an outer circumferential area of the flange portion is fixed to the main body” includes both a mode in which an inner circumferential area of the flange portion can be deformed in both the upward and downward directions (see FIGS. 1, 8 and 11) and a mode in which the upper surface side of the inner circumferential area of the flange portion is supported by a rigid member and thus the inner circumferential area cannot be deformed in the upward direction (see FIGS. 15, 17 and 19).

In addition, it is preferable that the holding core has: a truncated cone portion provided at the one end; a small diameter waisted portion provided adjacent to the truncated cone portion; and a large diameter columnar portion provided adjacent to the small diameter waisted portion and extending toward the movable core, and that the opening closure surface portion of the rubber valve is fixed to at least a part of the truncated cone portion of the holding core with a vulcanized adhesive such that the opening closure surface portion covers the truncated cone portion.

In a case in which such a configuration is adopted, undesired detachment between the holding core and the opening closure surface portion of the rubber valve is more effectively prevented.

Alternatively, it is preferable that the holding core has: a truncated cone portion provided at the one end; a small diameter waisted portion provided adjacent to the truncated cone portion; and a large diameter columnar portion provided adjacent to the small diameter waisted portion and extending toward the movable core, and that the opening closure surface portion of the rubber valve is fixed to at least a part of the truncated cone portion of the holding core and to at least a part of the small diameter waisted portion of the holding core with a vulcanized adhesive such that the opening closure surface portion covers the truncated cone portion and the small diameter waisted portion.

In a case in which such a configuration is adopted as well, undesired detachment between the holding core and the opening closure surface portion of the rubber valve is more effectively prevented.

Alternatively, it is preferable that the holding core has: a large diameter end portion provided at the one end; a small diameter waisted portion provided adjacent to the large diameter end portion; and a large diameter columnar portion provided adjacent to the small diameter waisted portion and extending toward the movable core, and that the opening closure surface portion of the rubber valve is fixed to at least a part of the large diameter end portion of the holding core with a vulcanized adhesive such that the opening closure surface portion covers the large diameter end portion.

In a case in which such a configuration is adopted as well, undesired detachment between the holding core and the opening closure surface portion of the rubber valve is more effectively prevented.

Alternatively, it is preferable that the holding core has: a large diameter end portion provided at the one end; a small diameter waisted portion provided adjacent to the large diameter end portion; and a large diameter columnar portion provided adjacent to the small diameter waisted portion and extending toward the movable core, and that the opening closure surface portion of the rubber valve is fixed to at least a part of the large diameter end portion of the holding core and to at least a part of the small diameter waisted portion of the holding core with a vulcanized adhesive such that the opening closure surface portion covers the large diameter end portion and the small diameter waisted portion.

In a case in which such a configuration is adopted as well, undesired detachment between the holding core and the opening closure surface portion of the rubber valve is more effectively prevented.

In addition, in any case in which any of the above embodiments is adopted, it is preferable that a lubricant is provided between the large diameter columnar portion of the holding core and the cylindrical portion of the rubber valve.

In this case, the cylindrical portion of the rubber valve can be deformed in an extended and shortened manner more smoothly, resulting in better operability of the rubber valve.

In general, the electromagnetic force applying part is configured to apply the electromagnetic force to the movable core in order to move the movable core and the holding core in one direction with respect to the rubber valve seating surface of the main body (for example, in a direction away from the rubber valve seating surface of the main body) such that the rubber valve is moved in the one direction with respect to the rubber valve seating surface (for example, in the direction away from the rubber valve seating surface). In addition, in general, a biasing member (for example, an elastic member such as a coil spring) is further provided which is configured to apply a biasing force (for example, an elastic force) to the movable core in order to move the movable core and the holding core in the other direction with respect to the rubber valve seating surface of the main body (for example, in a direction approaching the rubber valve seating surface of the main body) such that the rubber valve is moved in the other direction with respect to the rubber valve seating surface (for example, in the direction approaching the rubber valve seating surface), under a state wherein the electromagnetic force applying part is not applying the electromagnetic force to the movable core.

In such a case, it is preferable that, when the movable core and the holding core are moved in a direction approaching the rubber valve seating surface of the main body by the electromagnetic force or the biasing force, the cylindrical portion of the rubber valve is extended so that the rubber valve is seated on the rubber valve seating surface and the opening closure surface portion closes the opening, and that, when the movable core and the holding core are moved in a direction away from the rubber valve seating surface of the main body by the electromagnetic force or the biasing force, the cylindrical portion of the rubber valve is shortened so that the rubber valve further moves away from the rubber valve seating surface and the opening closure surface portion further opens the opening.

According to this feature, an unloaded state (natural state) of the cylindrical portion does not correspond to either a state in which the opening closure surface portion closes the opening or a state in which the opening closure surface portion is the furthest from the opening, but corresponds to a state between the above two states (preferably an intermediate state between them). Therefore, the deformation of the cylindrical portion includes both the extended deformation and the shortened deformation, and a maximum deformation value (also called an amplitude) of each of them is suppressed to be smaller than a case in which only the extended deformation occurs (the natural state corresponds to the maximum open state) or a case in which only the shortened deformation occurs (the natural state corresponds to the closed state) (if a position right in the middle is selected, the maximum deformation value is equal to each other for the extended deformation and the shortened deformation, and each is ½). This can suppress the occurrence of distortion due to deformation and further improve the durability of the rubber valve.

Herein, it is most preferable that a closing stroke of the cylindrical portion from an unloaded state of the cylindrical portion to a state in which the cylindrical portion is deformed in an extended manner so that the rubber valve is seated on the rubber valve seating surface and the opening closure surface portion closes the opening, and an opening stroke of the cylindrical portion from an unloaded state of the cylindrical portion to a state in which the cylindrical portion is deformed in an shortened manner so that the rubber valve further moves away from the rubber valve seating surface and the opening closure surface portion further opens the opening, are 1:1. Then, the maximum deformation value is equal to each other for the extended deformation and the shortened deformation, and thus each is ½. However, if the ratio is within a range of 2:1 to 1:2 (preferably, within a range of 3:2 to 2:3), the effects of the present invention can be expected.

In addition, a second aspect of the present invention is a rubber valve type of solenoid valve including: a main body having a rubber valve seating surface in which at least one flow channel is opened; a rubber valve configured to be seated on the rubber valve seating surface of the main body; a holding core having one end which holds the rubber valve; a movable core connected to the other end of the holding core; an electromagnetic force applying part configured to apply an electromagnetic force to the movable core in order to move the movable core and the holding core in one direction with respect to the rubber valve seating surface of the main body such that the rubber valve is moved in the one direction with respect to the rubber valve seating surface; and a biasing member configured to apply a biasing force to the movable core in order to move the movable core and the holding core in the other direction with respect to the rubber valve seating surface of the main body such that the rubber valve is moved in the other direction with respect to the rubber valve seating surface, under a state wherein the electromagnetic force applying part is not applying the electromagnetic force to the movable core, wherein a partial area of the rubber valve is fixed to the main body, another partial area of the rubber valve is fixed to the holding core (for example, with a vulcanized adhesive or by a fitting type of fixing method), when the movable core and the holding core are moved in a direction approaching the rubber valve seating surface of the main body by the electromagnetic force or the biasing force, the rubber valve is elastically deformed in the direction approaching the rubber valve seating surface so that the rubber valve is seated on the rubber valve seating surface to close the opening, and when the movable core and the holding core are moved in a direction away from the rubber valve seating surface of the main body by the electromagnetic force or the biasing force, the rubber valve is elastically deformed in the direction away from the rubber valve seating surface so that the rubber valve further moves away from the rubber valve seating surface to further open the opening.

According to the second aspect of the present invention, an unloaded state (natural state) of the rubber valve does not correspond to either a state in which the rubber valve closes the opening or a state in which the rubber valve is the furthest from the opening, but corresponds to a state between the above two states (preferably an intermediate state between them). Therefore, the deformation of the rubber valve includes both the elastic deformation in the direction approaching the rubber valve seating surface and the elastic deformation in the direction away from the rubber valve seating surface, and a maximum deformation value (also called an amplitude) of each of them is suppressed to be smaller than a case in which only the elastic deformation in the direction approaching the rubber valve seating surface occurs or a case in which only the elastic deformation in the direction away from the rubber valve seating surface occurs (if a position right in the middle is selected, the maximum deformation value is equal to each other for the elastic deformation in the direction approaching the rubber valve seating surface and the elastic deformation in the direction away from the rubber valve seating surface, and each is ½). This can suppress the occurrence of distortion due to deformation and further improve the durability of the rubber valve.

Herein, it is most preferable that a closing stroke of the rubber valve from an unloaded state of the rubber valve to a state in which the rubber valve is elastically deformed in the direction approaching the rubber valve seating surface so that the rubber valve is seated on the rubber valve seating surface to close the opening, and an opening stroke of the rubber valve from an unloaded state of the rubber valve to a state in which the rubber valve is elastically deformed in the direction away from the rubber valve seating surface so that the rubber valve further moves away from the rubber valve seating surface to further open the opening, are 1:1. Then, the maximum deformation value is equal to each other for the extended deformation and the shortened deformation, and thus each is ½. However, if the ratio is within a range of 2:1 to 1:2 (preferably, within a range of 3:2 to 2:3), the effects of the present invention can be expected.

### Advantageous Effects of Invention

According to the first aspect of the present invention, since the deformation of the cylindrical portion in an extended and shortened manner is utilized to cause an elastic deformation of the rubber valve, there is no need to provide any thinner part. Therefore, the issue of durability due to the existence of the thinner part can be fundamentally solved. In addition, according to this aspect, since the opening closure surface portion of the rubber valve and the holding core are fixed to each other (for example, with a vulcanized adhesive or by a fitting type of fixing method), the fixing between them is stronger. That is to say, according to this aspect, the movable core to which the electromagnetic force is applied and the holding core which holds the rubber valve are separately prepared and connected to each other, and thus the rubber valve can be integrally formed with the holding core by a baking process. For example, a corresponding mold can be prepared, and the rubber valve can be formed around a predetermined portion of the holding core by a baking process, so that the opening closure surface portion of the rubber valve and the holding core can be fixed with a vulcanized adhesive during the baking process.

According to the second aspect of the present invention, an unloaded state of the rubber valve does not correspond to either a state in which the rubber valve closes the opening or a state in which the rubber valve is the furthest from the opening but corresponds to a state between the above two states. Therefore, the deformation of the rubber valve includes both the extended deformation and the shortened deformation, and a maximum deformation value of each of them is suppressed to be smaller than a case in which only the extended deformation occurs or a case in which only the shortened deformation occurs. This can suppress the occurrence of distortion due to deformation and further improve the durability of the rubber valve.

### BRIEF DESCRIPTION OF DRAWINGS

FIG. 1 is a schematic longitudinal sectional view of a rubber valve type of solenoid valve according to an embodiment of the present invention;

FIG. 2 is a longitudinal sectional view of a rubber valve of the rubber valve type of solenoid valve shown in FIG. 1;

FIG. 3 is a front view of a movable core and a holding core of the rubber valve type of solenoid valve shown in FIG. 1;

FIG. 4 is a longitudinal sectional view of a main body of the rubber valve type of solenoid valve shown in FIG. 1;

FIG. 5 is a perspective view of a rubber valve seating surface of the rubber valve type of solenoid valve shown in FIG. 1;

FIG. 6 is a schematic view of a valve closure state of the rubber valve type of solenoid valve shown in FIG. 1;

FIG. 7 is a schematic view of a maximum valve open state of the rubber valve type of solenoid valve shown in FIG. 1;

FIG. 8 is a schematic longitudinal sectional view of a rubber valve type of solenoid valve according to another embodiment of the present invention;

FIG. 9 is a schematic view of a valve closure state of the rubber valve type of solenoid valve shown in FIG. 8;

FIG. 10 is a schematic view of a maximum valve open state of the rubber valve type of solenoid valve shown in FIG. 8;

FIG. 11 is a schematic longitudinal sectional view of a rubber valve type of solenoid valve according to further another embodiment of the present invention;

FIG. 12 is a longitudinal sectional view of a holding core and a rubber valve of the rubber valve type of solenoid valve shown in FIG. 11;

FIG. 13 is a schematic view for explaining a baking process of the rubber valve of the rubber valve type of solenoid valve shown in FIG. 11;

FIG. 14 is a schematic sectional view of a conventional rubber valve type of solenoid valve;

FIG. 15 is a schematic longitudinal sectional view of a first modified example of the rubber valve type of solenoid valve shown in FIG. 1;

FIG. 16 is a longitudinal sectional view of a modified example of the rubber valve shown in FIG. 2;

FIG. 17 is a schematic longitudinal sectional view of a second modified example of the rubber valve type of solenoid valve shown in FIG. 1, in which the rubber valve shown in FIG. 16 is incorporated;

FIG. 18 is a longitudinal sectional view of another modified example of the rubber valve shown in FIG. 2; and

FIG. 19 is a schematic longitudinal sectional view of a third modified example of the rubber valve type of solenoid valve shown in FIG. 1, in which the rubber valve shown in FIG. 18 is incorporated.

### EMBODIMENTS OF INVENTION

Hereinafter, embodiments of the present invention are explained with reference to the attached drawings.

### An Embodiment

### Structure

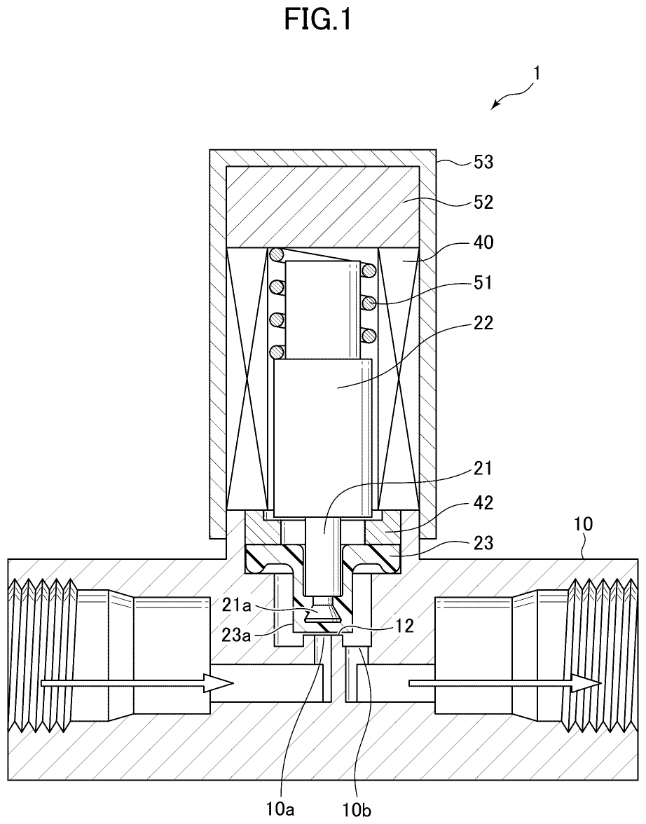

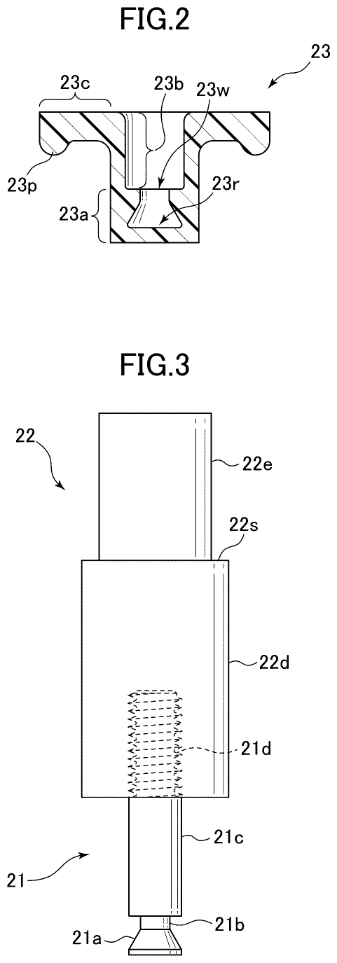

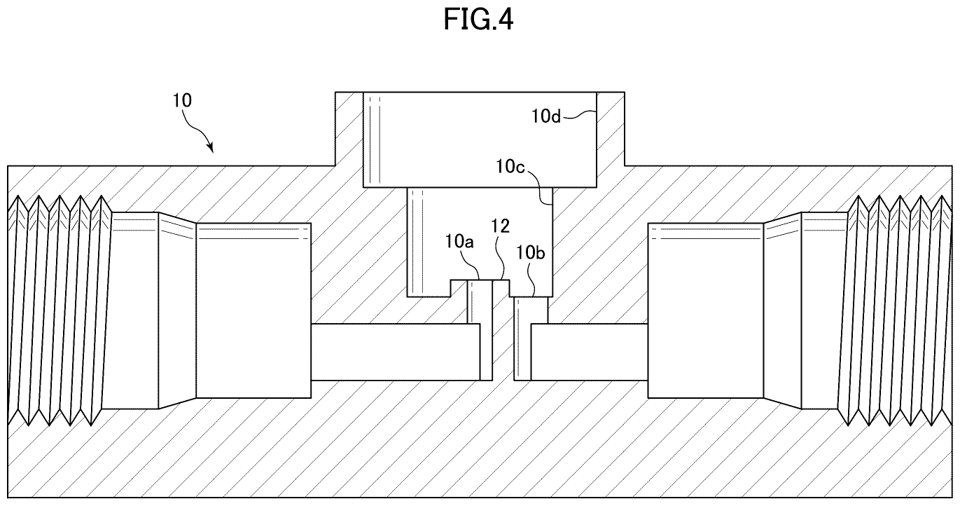

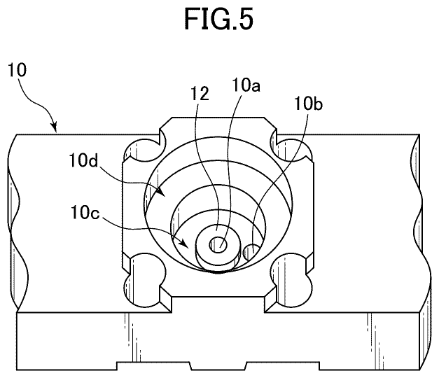

FIG. 1 is a schematic longitudinal sectional view of a rubber valve type of solenoid valve according to an embodiment of the present invention. FIG. 2 is a longitudinal sectional view of a rubber valve of the rubber valve type of solenoid valve shown in FIG. 1. FIG. 3 is a front view of a movable core and a holding core of the rubber valve type of solenoid valve shown in FIG. 1. FIG. 4 is a longitudinal sectional view of a main body of the rubber valve type of solenoid valve shown in FIG. 1. FIG. 5 is a perspective view of a rubber valve seating surface of the rubber valve type of solenoid valve shown in FIG. 1.

As shown in FIG. 1, the rubber valve type of solenoid valve 1 of the present embodiment includes: a main body 10 having a rubber valve seating surface 12 in which one opening 10a is provided; a rubber valve 23 configured to be seated on the rubber valve seating surface 12 of the main body 10; a holding core 21 having one end (a lower end in FIG. 1) which holds the rubber valve 23; and a movable core 22 connected to the other end (an upper end in FIG. 1) of the holding core 21.

The movable core 22 is provided in a movable manner in an axial direction with respect to a fixed core 52 via a coil spring 51 (an example of a biasing member).

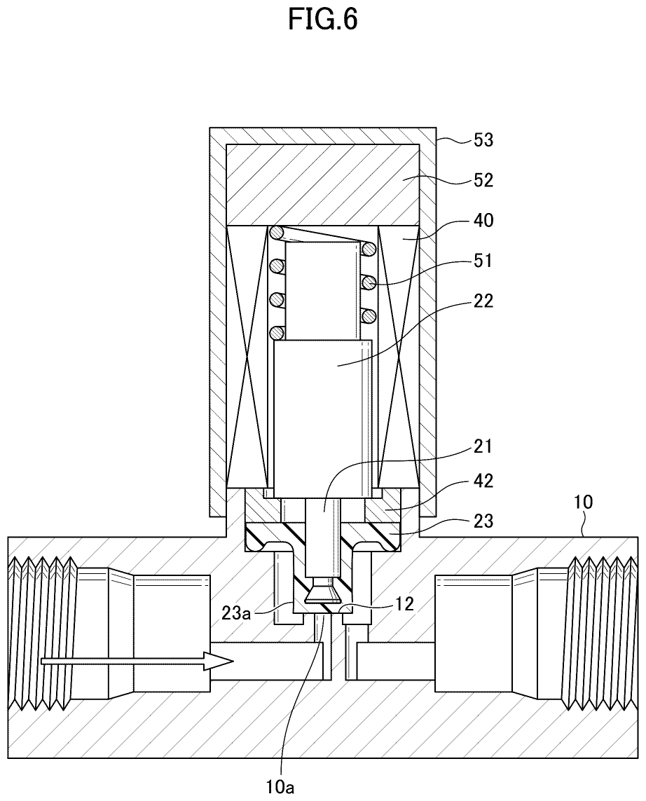

The coil spring 51 is configured to apply an elastic force (an example of a biasing force) to the movable core 22 in order to bias the movable core 22 and the holding core 21 with respect to the rubber valve seating surface 12 of the main body 10 such that an opening closure surface portion 23a of the rubber valve 23 abuts against (is seated on) the rubber valve seating surface 12 (a cylindrical portion 23b is deformed in an extended manner: see FIG. 6).

In addition, the rubber valve type of solenoid valve 1 of the present embodiment further includes an electromagnetic force applying part 40 (for example, an electromagnetic coil), which is configured to apply an electromagnetic force to the movable core 22 in order to move the movable core 22 and the holding core 21 with respect to the rubber valve seating surface 12 of the main body 10 such that the rubber valve 23 is moved with respect to the rubber valve seating surface 12. As shown in FIG. 1, the electromagnetic force applying part 40, the fixed core 52 and an upper end of the main body 10 are covered by a cover 53.

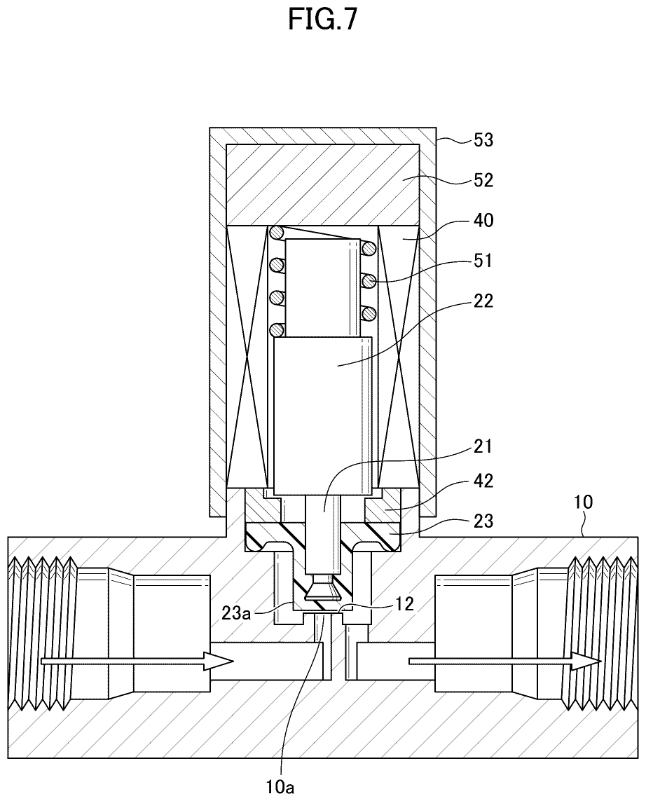

Furthermore, the electromagnetic force applying part 40 of the present embodiment is configured to apply an electromagnetic force to the movable core 22 in order to move the movable core 22 and the holding core 21 in a direction away from the rubber valve seating surface 12 of the main body 10 such that the rubber valve 23 is moved away from the rubber valve seating surface 12 (the cylindrical portion 23b is deformed in an shortened manner: see FIG. 7). The movable core 22 of the present embodiment is made of magnetic stainless steel (K-M31).

Herein, at least at the time of filing the present application, the present invention does not exclude another pattern in which the rubber valve 23 is subjected to an elastic force and separated from the rubber valve seating surface 12 before an electromagnetic force is applied to the movable core 22, and the rubber valve 23 abuts against (is seated on) the rubber valve seating surface 12 (the cylindrical portion 23b is deformed in an extended manner) when an electromagnetic force is applied to the movable core 22.

Next, as shown in FIG. 2, the rubber valve 23 of the present embodiment has: the opening closure surface portion 23a; the cylindrical portion 23b which extends from the opening closure surface portion 23a towards the holding core 21; and a flange portion 23c which annularly extends on an outer side than an end of the cylindrical portion 23b on a side of the holding core 21. The rubber valve 23 of the present embodiment is made of EPDM (ethylene propylene diene rubber) and has a hardness of, for example, A70±5.

In addition, as shown in FIG. 3, the holding core 21 has a truncated cone portion 21a at the one end on the side of the opening closure surface portion 23a. Furthermore, the holding core 21 has a small diameter cylindrical portion 21b (a part of a small diameter waisted portion) provided adjacent to the truncated cone portion 21a, a large diameter cylindrical portion 21c (an example of a large diameter columnar portion) provided adjacent to the small diameter cylindrical portion 21b and extending toward the movable core 22, and a male threaded portion 21d for threadedly engaging with the movable core 22. The male threaded portion 21d can be replaced with any other known connecting element (for example, a mode in which the holding core 21 and the movable core 22 are snap-fitted to each other can also be adopted). The holding core 21 of the present embodiment is made of stainless steel (magnetic properties are not required).

As shown in FIGS. 1 and 2, the opening closure surface portion 23a of the rubber valve 23 covers the truncated cone portion 21a and the small diameter cylindrical portion 21b of the holding core 21.

The opening closure surface portion 23a of the rubber valve 23 is fixed by a vulcanized adhesive to an end surface (a lower end surface in FIG. 1) of the truncated cone portion 21a, a circumferential surface of the truncated cone portion 21a, and a circumferential surface of the small diameter cylindrical portion 21b. That is to say, the rubber valve 23 is integrally molded with the holding core 21 by a baking process (FIGS. 2 and 3 are separately shown only for the sake of convenience of explanation, but in fact the holding core 21 and the movable core 22 are separable and the holding core 21 and the rubber valve 23 are integrally molded).

In the present embodiment, the vulcanized adhesive is not applied to the lower surface of the large diameter cylindrical portion 21c (another part of the small diameter waisted portion) adjacent to the circumferential surface of the small diameter cylindrical portion 21b. In this way, the presence of an area where the vulcanized adhesive is not applied prevents the vulcanized adhesive applied to the circumferential surface of the small diameter cylindrical portion 21b from undesirably reaching the circumferential surface of the large diameter cylindrical portion 21c.

As shown in FIGS. 1 and 3, the movable core 22 has a second cylindrical portion 22e on the side of the fixed core 52, and a first cylindrical portion 22d which forms a step portion 22s between itself and the second cylindrical portion 22e.

As an example of dimensions, the second cylindrical portion 22e has a length of 5 mm and a diameter of 3.9 mm, the first cylindrical portion 22d has a length of 8.1 mm and a diameter of 5.0 mm, the large diameter cylindrical portion 21c has a length of 4.1 mm and a diameter of 1.8 mm, the small diameter cylindrical portion 21b has a length of 0.4 mm and a diameter of 1.0 mm, and the truncated cone portion 21a has a length of 0.9 mm, a maximum diameter of 1.8 mm, and an apex angle of about 60°.

The coil spring 51 has a natural length of 7.7 mm and is inserted between the step portion 22s and the fixed core 52 under a compressed state (in an opening closure state (see FIG. 6), the length of the coil spring 51 is 5.3 mm). The spring constant of the coil spring 51 is 0.9 N/mm.

Returning to FIG. 2, the outer shape of the opening closure surface portion 23a of the rubber valve 23 has a cylindrical portion with a diameter of 3 mm and a height of 1.8 mm, and is provided at an upper center thereof with a truncated cone recess 23r into which the truncated cone portion 21a of the holding core 21 can be fitted, and with a small diameter cylindrical recess 23w into which the small diameter cylindrical portion 21b of the holding core 21 can be fitted. The truncated cone recess 23r has an apex angle of about 60°, a bottom diameter (maximum diameter) of 1.8 mm (with R0.1) and an upper end portion with R0.2. The upper side of this R0.2 area is continuous with the small diameter cylindrical recess 23w. The height of the opening closure surface portion 23a to the upper surface of the small diameter cylindrical recess 23w is 1.8 mm. The height of the opening closure surface portion 23a to the lower surface of the small diameter cylindrical recess 23w is 1.4 mm. The depth of the truncated cone recess 23r to the lower surface of the small diameter cylindrical recess 23w is 0.9 mm.

The cylindrical portion 23b of the rubber valve 23 is a circular cylindrical portion having an inner diameter of 2.0 mm, an outer diameter of 3.0 mm, and a length of 2.7 mm, and extends from the upper surface of the opening closure surface portion 23a toward the holding core 21.

The flange portion 23c of the rubber valve 23 extends outward in an annular shape from the end of the cylindrical portion 23b on the side of the holding core 21. The flange portion 23c of the present embodiment has an outer diameter of 8.0 mm and a uniform thickness of 1.0 mm. That is to say, the flange portion 23c of the present embodiment does not have a thinner part. On the other hand, a lower surface of an outer peripheral area of the flange portion 23c is provided with an annular protrusion 23p having a semicircular cross section of R0.5 for fixing to the main body 10. In addition, the outer surface of the cylindrical portion 23b and the lower surface of the flange portion 23c are smoothly continuous (with R) (for example, R0.5). The lower surface of the flange portion 23c and the protrusion 23p are also smoothly continuous (with R) (for example, R0.3).

Next, as shown in FIG. 4, the main body 10 of the present embodiment is provided with a large diameter hole 10d in which the flange portion 23c of the rubber valve 23 is placed. The large diameter hole 10d is a cylindrical hole having a diameter of 8.1 mm and a height of 3.2 mm.

As shown in FIG. 1, the flange portion 23c placed in the large diameter hole 10d is fixed to the main body 10 under a compressed state from above via an annular pressing part (also called an adapter) 42, which has the same outer diameter (8 mm) as the flange portion 23c, and via the electromagnetic force applying part 40. Specifically, an outer area (an area outer than the diameter of 6 mm) of the annular pressing part 42 has a height of 2.0 mm, and the annular protrusion 23p of the flange portion 23c is fixed under a compressed state by 0.3 mm. On the other hand, an inner area (an area inner than the diameter of 6 mm) of the annular pressing part 42 of the present embodiment has a height of 1.4 mm and an inner diameter of 4 mm, which is slightly smaller than the outer diameter (5 mm) of the first cylindrical portion 22d of the movable core 22, and functions as a stopper that defines a downward movement limit of the movable core 22.

It is preferable that an inner circumferential surface and an upper surface of the annular pressing part 42 are smoothly continuous (with R) (for example, R0.2). Similarly, it is preferable that the inner circumferential surface and a lower surface of the annular pressing part 42 are smoothly continuous (with R) (for example, R0.2).

It is also possible to configure the entire annular pressing part 42 with a flat height without providing a difference in height between the outer area and the inner area of the annular pressing part 42.

A small diameter hole 10c is provided below the large diameter hole 10d to be coaxial with the large diameter hole 10d. The small diameter hole 10c is a cylindrical hole having a diameter of 5.0 mm and a height of 3.8 mm. The cylindrical portion 23b and the opening closure surface portion 23a are inserted into the small diameter hole 10c.

Herein, as one feature of the preset embodiment, when neither an electromagnetic force nor an elastic force is applied, i.e., when the rubber valve 23 is in an unloaded state, (the bottom surface of) the opening closure surface portion 23a is located at a height half the maximum open height from the rubber valve seating surface 12. This feature is an essential feature of the second aspect of the present invention. However, this feature is optional (not essential) for the first aspect of the present invention.

An area of the main body 10 on the side of the rubber valve seating surface 12 is formed as an area that protrudes in a cylindrical shape from the bottom surface of the small diameter hole 10c. The area that protrudes in a cylindrical shape has an outer diameter of 2.0 mm and a height of 0.5 mm.

An opening 10a (having a diameter of 0.8 mm) is provided in the rubber valve seating surface 12 coaxially with the large diameter hole 10d and the small diameter hole 10c. Another opening 10b (having a diameter of 1.2 mm) is provided in the bottom surface of the small diameter hole 10c at a position away from the area that protrudes in a cylindrical shape (which area provides the rubber valve seating surface 12) (see FIG. 5).

Flow channels, which lead to the respective openings 10a, 10b, extend downward in the main body 10, and then extend away from each other symmetrically in a left and right direction (horizontal direction). The diameter of a portion of each flow channel that extends in the left and right direction (horizontal direction) is, for example, about 2.0 mm. The depth of each flow channel to an axis of the portion is, for example, about 2.0 mm with respect to the bottom surface of the small diameter hole 10c. The portion is continuous with a threaded hole for connecting to a pipe.

The main body 10 of the present embodiment is formed by an injection molding process from a PPS resin, including the valve rubber seating surface 12. However, a PBT resin may be used instead of the PPS resin. In addition, the area that provides the valve rubber seating surface 12 and the other area below it may be configured as separate bodies and may be made of different materials.

### Operation

Under a state wherein the electromagnetic force applying part 40 is not applying an electromagnetic force to the movable core 22, the movable core 22 is biased in a direction approaching the rubber valve seating surface 12 of the main body 10, by an elastic force of the coil spring 51. Thereby, as shown in FIG. 6, the cylindrical portion 23b of the rubber valve 23 is deformed in an extended manner and a partial area of the flange portion 23c located on the inner side than the pushing part 42 is very slightly deformed as a diaphragm valve, so that the rubber valve 23 is seated on the rubber valve seating surface 12 and the opening closure surface portion 23a closes (seals) the opening 10a.

Based on a controlling instruction from a controller not shown, the electromagnetic force applying part 40 applies an electromagnetic force to the movable core 22. Thereby, the movable core 22 is moved in a direction away from the rubber valve seating surface 12 of the main body 10, and thus the rubber valve 23 is moved in the same direction away from the rubber valve seating surface 12. Thereby, as shown in FIG. 7, the cylindrical portion 23b of the rubber valve 23 is deformed in a shortened manner and the partial area of the flange portion 23c located on the inner side than the pushing part 42 is very slightly deformed as a diaphragm valve, so that the rubber valve 23 is separated from the rubber valve seating surface 12 and the opening 10a is opened.

In the present embodiment, a closing stroke of the cylindrical portion 23b from an unloaded state of the cylindrical portion 23b to a state in which the cylindrical portion 23b is deformed in an extended manner so that the rubber valve 23 is seated on the rubber valve seating surface 12 and the opening closure surface portion 23a closes the opening 10a is about 0.15 mm.

In addition, in the present embodiment, an opening stroke of the cylindrical portion 23b from an unloaded state of the cylindrical portion 23b to a state in which the cylindrical portion 23b is deformed in an shortened manner so that the rubber valve 23 further moves away from the rubber valve seating surface 12 and the opening closure surface portion 23a further opens the opening 10a is about 0.15 mm.

That is to say, in the present embodiment, the ratio between the closing stroke of the cylindrical portion 23b and the opening stroke of the cylindrical portion 23b is about 1:1.

### Effects

According to the rubber valve type of solenoid valve 1 of the present embodiment as described above, since the deformation of the cylindrical portion 23b in an extended and shortened manner is utilized to cause an elastic deformation of the rubber valve 23b, there is no need to provide any thinner part. Therefore, the issue of durability due to the existence of the thinner part can be fundamentally solved.

Specifically, the flange portion 23c of the present embodiment does not have any so-called thinner part and has a thickness of 1.0 mm or more at any position. This feature can achieve very high durability.

In addition, according to the present embodiment, since the opening closure surface portion 23a of the rubber valve 23 and the holding core 21 are fixed to each other with a vulcanized adhesive, the fixing between them is stronger. That is to say, according to the present embodiment, the movable core 22 to which the electromagnetic force is applied and the holding core 21 which holds the rubber valve 23 are separately prepared and connected to each other, and thus the rubber valve 23 can be integrally formed with the holding core 21 by a baking process. For example, a corresponding mold can be prepared, and the rubber valve 23 can be formed around a predetermined portion of the holding core 21 by a baking process, so that the opening closure surface portion 23a of the rubber valve 23 and the holding core 21 can be fixed with a vulcanized adhesive during the baking process.

In addition, according to the present embodiment, the holding core 21 has the truncated cone portion 21a and the small diameter cylindrical portion 21b (a part of a small diameter waisted portion) at the end portion thereof on the side of the opening closure surface portion 23a, and the opening closure surface portion 23a of the rubber valve 23 has the truncated cone recess 23r and the small diameter cylindrical recess 23w which respectively cover the truncated cone portion 21a and the small diameter cylindrical portion 21b of the holding core 21. The engagement relationship brought about by these shapes also effectively prevents undesired detachment between the holding core 21 and the opening closure surface portion 23a of the rubber valve 23.

In addition, according to the present embodiment, the electromagnetic force applying part 40 is configured to apply the electromagnetic force to the movable core 22 in order to move the movable core 22 and the holding core 21 in a direction away from the rubber valve seating surface 12 of the main body 10 such that the rubber valve 23 is moved in the direction away from the rubber valve seating surface 12, and the coil spring 51 is configured to apply the elastic force to the movable core 22 in order to move the movable core 22 and the holding core 21 in a direction approaching the rubber valve seating surface 12 of the main body 10 such that the rubber valve 23 is moved in the direction approaching the rubber valve seating surface 12 under a state wherein the electromagnetic force applying part 40 is not applying the electromagnetic force to the movable core 22.

Furthermore, when only the elastic force is applied (when the electromagnetic force is not applied), the cylindrical portion 23b of the rubber valve 23 is deformed in an extended manner (and a partial area of the flange portion 23c located on the inner side than the pushing part 42 is very slightly deformed as a diaphragm valve), so that the rubber valve 23 is seated on the rubber valve seating surface 12 and the opening closure surface portion 23a closes (seals) the opening 10a. When the electromagnetic force is applied (the elastic force is also applied, but the elastic force is greater than the elastic force), the cylindrical portion 23b of the rubber valve 23 is deformed in a shortened manner (and the partial area of the flange portion 23c located on the inner side than the pushing part 42 is very slightly deformed as a diaphragm valve), so that the rubber valve 23 further moves away from the rubber valve seating surface 12 and the opening closure surface portion 23a further opens the opening 10a.

That is to say, according to the rubber valve type of solenoid valve 1 of the present embodiment, an unloaded state (natural state) of the cylindrical portion 23b does not correspond to either a state in which the opening closure surface portion 23a closes the opening 10a or a state in which the opening closure surface portion 23a is the furthest from the opening 10a, but corresponds to an intermediate state between the above two states. Therefore, the deformation of the cylindrical portion 23b includes both the extended deformation and the shortened deformation, and the maximum deformation value of each of them is suppressed to be smaller than a case in which only the extended deformation occurs (the natural state corresponds to the maximum open state) or a case in which only the shortened deformation occurs (the natural state corresponds to the closed state). This can suppress the occurrence of distortion due to deformation and further improve the durability of the rubber valve 23.

In addition, in the present embodiment, the ratio between the closing stroke of the cylindrical portion 23b and the opening stroke of the cylindrical portion 23b is about 1:1. However, if the ratio is within a range of 2:1 to 1:2 (preferably, within a range of 3:2 to 2:3), the effects of the present invention can be expected.

Furthermore, according to the rubber valve type of solenoid valve 1 of the present embodiment, the closed state of the opening 10a is maintained by the elastic force of the coil spring 51. Therefore, no power consumption is required in the closed state of the opening 10a. This feature can achieve high energy saving effects.

Specifically, the inventors of the present invention have confirmed that, when an ink intended for commercial-use printers is used as the fluid for the rubber valve type of solenoid valve 1 of the present embodiment and the pressure range applied to the flow channel on the “IN” side is set to −70 to 420 kPa, a flow/a stop of the ink can be controlled smoothly and such controlling performances can have a longer life.

In addition, in the present embodiment as described above, only one opening 10a is provided in the rubber valve seating surface 12, and another opening 10b is provided in the bottom surface of the small diameter hole 10c, but the present invention is not limited to this manner. Another type may be adopted in which two openings are provided in the rubber valve seating surface 12.

In addition, in the present embodiment as described above, the coil spring 51, which is an elastic member, is used as the biasing means. However, instead of this, a mechanism or configuration that applies an air pressure or a liquid pressure to the movable core 22 may be adopted.

In addition, in the present embodiment as described above, the vulcanized adhesive is provided on the end surface of the truncated cone portion 21a, on the circumferential surface of the truncated cone portion 21a, and on the circumferential surface of the small diameter cylindrical portion 21b. However, another manner wherein the vulcanized adhesive is provided on the end surface of the truncated cone portion 21a and on the circumferential surface of the truncated cone portion 21a but is not provided on the circumferential surface of the small diameter cylindrical portion 21b is also within the range of the present invention, at least at the time of filing the present application.

Furthermore, further another manner wherein the vulcanized adhesive is provided on the end surface of the truncated cone portion 21a, on the circumferential surface of the truncated cone portion 21a and on a lower area of the circumferential surface of the small diameter cylindrical portion 21b but is not provided on an upper area of the circumferential surface of the small diameter cylindrical portion 21b is also within the range of the present invention, at least at the time of filing the present application.

Furthermore, yet further another manner wherein the vulcanized adhesive is provided on the end surface of the truncated cone portion 21a, on the circumferential surface of the truncated cone portion 21a, on the circumferential surface of the small diameter cylindrical portion 21b and on an inner peripheral area of the lower surface of the large diameter cylindrical portion 21c (another part of a small diameter waisted portion) but is not provided on an outer peripheral area of the lower surface of the large diameter cylindrical portion 21c is also within the range of the present invention, at least at the time of filing the present application.

In short, in the present embodiment, it is preferable to interpose an area where the vulcanized adhesive is not applied between the truncated cone portion 21a and the circumferential surface of the large diameter cylindrical portion 21c, in order to prevent the vulcanized adhesive applied on the truncated cone portion 21a from undesirably reaching the circumferential surface of the large diameter cylindrical portion 21c.

In addition, the feature wherein an unloaded state (natural state) of the rubber valve does not correspond to either a state in which the rubber valve closes the opening or a state in which the rubber valve is the furthest from the opening but corresponds to an intermediate state between the above two states is also effective in other types of solenoid valve different from the embodiment as described above.

However, this feature is optional (not essential) for the first aspect of the present invention. That is to say, a modified manner wherein an unloaded state (natural state) of the rubber valve corresponds to the state in which the rubber valve closes the opening can also have sufficiently advantageous effects, and another modified manner wherein an unloaded state (natural state) of the rubber valve corresponds to the state in which the rubber valve is the furthest from the opening can also have sufficiently advantageous effects.

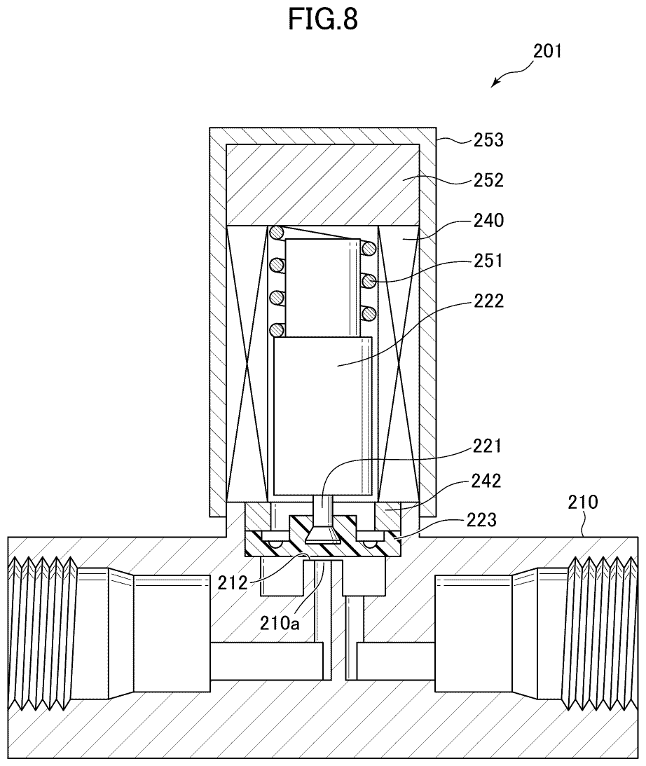

As another embodiment wherein an unloaded state (natural state) of the rubber valve does not correspond to either a state in which the rubber valve closes the opening or a state in which the rubber valve is the furthest from the opening but corresponds to an intermediate state between the above two states, a rubber valve type of solenoid valve according to another embodiment of the present invention is explained with reference to FIGS. 8 to 10.

### Another Embodiment

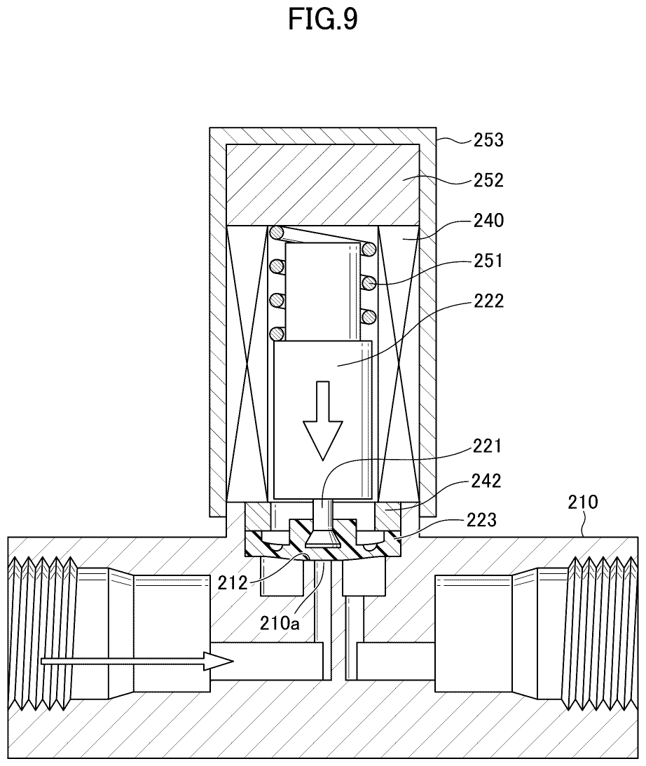

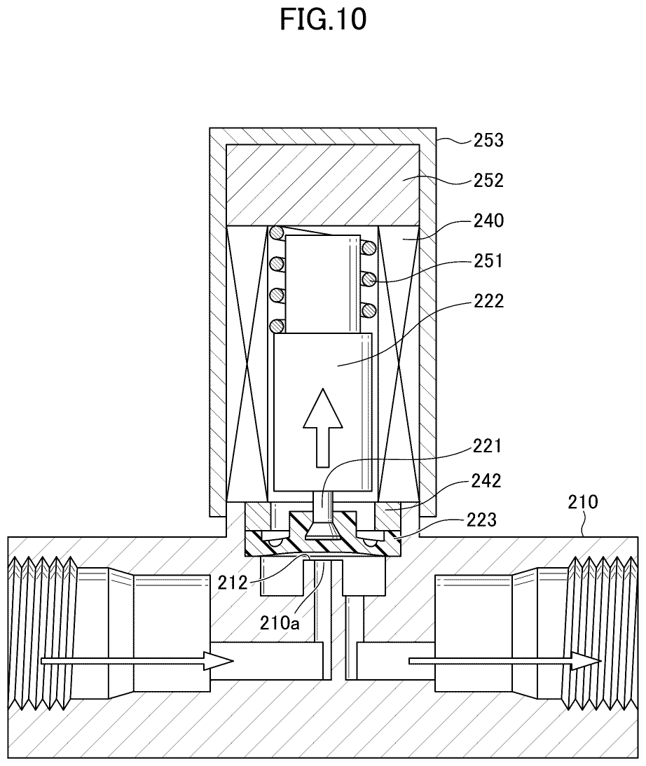

FIG. 8 is a schematic longitudinal sectional view of a rubber valve type of solenoid valve according to another embodiment of the present invention. FIG. 9 is a schematic view of a valve closure state of the rubber valve type of solenoid valve. FIG. 10 is a schematic view of a maximum valve open state of the rubber valve type of solenoid valve.

### Structure

As shown in FIG. 8, the rubber valve type of solenoid valve 201 of the present embodiment includes: a main body 210 having a rubber valve seating surface 212 in which one opening 210a is provided; a rubber valve 223 configured to be seated on the rubber valve seating surface 212 of the main body 210; a holding core 221 having one end (a lower end in FIG. 8) which holds the rubber valve 223; and a movable core 222 connected to the other end (an upper end in FIG. 8) of the holding core 221.

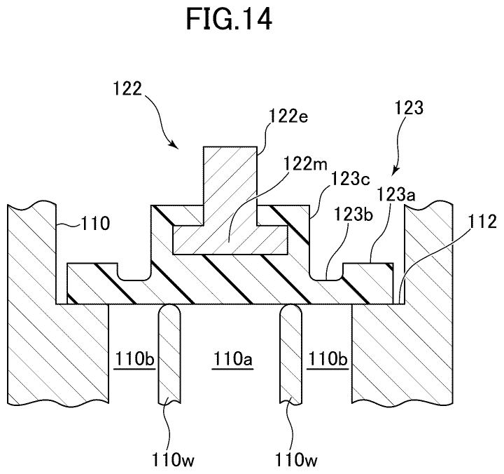

Unlike the rubber valve type of solenoid valve 1 explained with reference to FIGS. 1 to 7, the rubber valve 223 in the rubber valve type of solenoid valve 201 of the present embodiment has a form of diaphragm valve which has been conventionally known (see FIG. 14).

On the other hand, substantially similarly to the rubber valve type of solenoid valve 1 explained with reference to FIGS. 1 to 7, the movable core 222 is provided in a movable manner in an axial direction with respect to a fixed core 252 via a coil spring 251 (an example of a biasing member).

The coil spring 251 is configured to apply an elastic force (an example of a biasing force) to the movable core 222 in order to bias the movable core 222 and the holding core 221 with respect to the rubber valve seating surface 212 of the main body 210 such that the rubber valve 223 abuts against (is seated on) the rubber valve seating surface 212 (see FIG. 9).

In addition, substantially similarly to the rubber valve type of solenoid valve 1 explained with reference to FIGS. 1 to 7, the rubber valve type of solenoid valve 201 of the present embodiment further includes an electromagnetic force applying part 240 (for example, an electromagnetic coil), which is configured to apply an electromagnetic force to the movable core 222 in order to move the movable core 222 and the holding core 221 with respect to the rubber valve seating surface 212 of the main body 210 such that the rubber valve 223 is moved with respect to the rubber valve seating surface 212. As shown in FIG. 8, the electromagnetic force applying part 240, the fixed core 252 and an upper end of the main body 210 are covered by a cover 253.

Furthermore, the electromagnetic force applying part 240 of the present embodiment is configured to apply an electromagnetic force to the movable core 222 in order to move the movable core 222 and the holding core 221 in a direction away from the rubber valve seating surface 212 of the main body 10 such that the rubber valve 223 is moved away from the rubber valve seating surface 212 (see FIG. 10). The movable core 222 of the present embodiment is made of magnetic stainless steel (K-M31).

Herein, at least at the time of filing the present application, the present invention does not exclude another pattern in which the rubber valve 223 is subjected to an elastic force and separated from the rubber valve seating surface 212 before an electromagnetic force is applied to the movable core 222, and the rubber valve 223 abuts against (is seated on) the rubber valve seating surface 212 when an electromagnetic force is applied to the movable core 222.

In addition, the rubber valve 223 of the present embodiment is made of EPDM (ethylene propylene diene rubber) and has a hardness of, for example, A70±5.

In addition, as shown in FIG. 8, the holding core 221 has a truncated cone portion at one end on the side of an opening closure surface portion. Furthermore, the holding core 221 has a cylindrical portion provided adjacent to the truncated cone portion and a male threaded portion (not shown) for threadedly engaging with the movable core 222. The male threaded portion can be replaced with any other known connecting element (for example, a mode in which the holding core 221 and the movable core 222 are snap-fitted to each other can also be adopted). The holding core 221 of the present embodiment is also made of stainless steel (magnetic properties are not required).

As shown in FIG. 8, the opening closure surface portion of the rubber valve 223 covers the truncated cone portion and the cylindrical portion of the holding core 221.

The opening closure surface portion of the rubber valve 223 is fixed by a vulcanized adhesive to an end surface (a lower end surface in FIG. 8) of the truncated cone portion and a circumferential surface of the truncated cone portion. That is to say, the rubber valve 223 is integrally molded with the holding core 221 by a baking process.

The coil spring 251 has a natural length of 7.7 mm and is inserted between the step portion and the fixed core 252 under a compressed state (in an opening closure state (see FIG. 9), the length of the coil spring 251 is 5.3 mm). The spring constant of the coil spring 251 is 0.9 N/mm.

In addition, as shown in FIG. 8, the main body 210 of the present embodiment is provided with a large diameter hole in which the flange portion of the rubber valve 223 is placed.

As shown in FIG. 8, the flange portion of the rubber valve 223 placed in the large diameter hole is fixed to the main body 210 under a compressed state from above via an annular pressing part (also called an adapter) 242 and the electromagnetic force applying part 240.

A small diameter hole is provided below the large diameter hole to be coaxial with the large diameter hole. An area of the main body 210 on the side of the rubber valve seating surface 212 is formed as an area that protrudes in a cylindrical shape from the bottom surface of the small diameter hole.

Herein, as one feature of the preset embodiment, when neither an electromagnetic force nor an elastic force is applied, i.e., when the rubber valve 223 is in an unloaded state, (the bottom surface of) the opening closure surface portion of the rubber valve 223 is located at a height half the maximum open height from the rubber valve seating surface 212 (see FIG. 8). This feature is an essential feature of the second aspect of the present invention.

The other structure of the rubber valve type of solenoid valve 201 of the present embodiment is substantially the same as the rubber valve type of solenoid valve 1 explained with reference to FIGS. 1 to 7.

### Operation

Under a state wherein the electromagnetic force applying part 240 is not applying an electromagnetic force to the movable core 222, the movable core 222 and the holding core 221 are biased in a direction approaching the rubber valve seating surface 212 of the main body 210, by an elastic force of the coil spring 251. Thereby, as shown in FIG. 9, the rubber valve 223 is elastically deformed, so that the rubber valve 223 is seated on the rubber valve seating surface 212 and the opening closure surface portion closes (seals) the opening 210a.

Based on a controlling instruction from a controller not shown, the electromagnetic force applying part 240 applies an electromagnetic force to the movable core 222. Thereby, the movable core 222 and the holding core 221 are moved in a direction away from the rubber valve seating surface 212 of the main body 210, and thus the rubber valve 223 is moved in the same direction away from the rubber valve seating surface 212. Thereby, as shown in FIG. 10, the rubber valve 23 is elastically deformed in the opposite direction, so that the rubber valve 223 is separated from the rubber valve seating surface 212 and the opening 210a is opened.

In the present embodiment, a closing stroke of the rubber valve 223 from an unloaded state of the rubber valve 223 to a state in which the rubber valve 223 is elastically deformed so that the rubber valve 223 is seated on the rubber valve seating surface 212 and the opening closure surface portion closes the opening 210a is about 0.15 mm.

In addition, in the present embodiment, an opening stroke of the rubber valve 223 from an unloaded state of the rubber valve 223 to a state in which the rubber valve 223 is elastically deformed so that the rubber valve 223 further moves away from the rubber valve seating surface 212 and the opening closure surface portion further opens the opening 210a is about 0.15 mm.

That is to say, in the present embodiment, the ratio between the closing stroke of the rubber valve 223 and the opening stroke of the rubber valve 223 is about 1:1.

### Effects

According to the present embodiment, the electromagnetic force applying part 240 is configured to apply the electromagnetic force to the movable core 222 in order to move the movable core 222 and the holding core 221 in a direction away from the rubber valve seating surface 212 of the main body 210 such that the rubber valve 223 is moved in the direction away from the rubber valve seating surface 212, and the coil spring 251 is configured to apply the elastic force to the movable core 222 in order to move the movable core 222 and the holding core 221 in a direction approaching the rubber valve seating surface 212 of the main body 210 such that the rubber valve 223 is moved in the direction approaching the rubber valve seating surface 212 under a state wherein the electromagnetic force applying part 240 is not applying the electromagnetic force to the movable core 222.

Furthermore, when only the elastic force is applied (when the electromagnetic force is not applied), the rubber valve 223 is elastically deformed, so that the rubber valve 223 is seated on the rubber valve seating surface 212 and the opening closure surface portion closes (seals) the opening 210a. When the electromagnetic force is applied (the elastic force is also applied, but the elastic force is greater than the elastic force), the rubber valve 223 is elastically deformed in the opposite direction, so that the rubber valve 223 further moves away from the rubber valve seating surface 212 and the opening closure surface portion further opens the opening 210a.

That is to say, according to the rubber valve type of solenoid valve 201 of the present embodiment, an unloaded state (natural state) of the rubber valve 223 does not correspond to either a state in which the opening closure surface portion closes the opening 210a or a state in which the opening closure surface portion is the furthest from the opening 210a, but corresponds to an intermediate state between the above two states. Therefore, the elastic deformation of the rubber valve 223 includes both the downward elastic deformation and the upward elastic deformation, and the maximum deformation value of each of them is suppressed to be smaller than a case in which only the downward elastic deformation occurs (the natural state corresponds to the maximum open state) or a case in which only the upward elastic deformation occurs (the natural state corresponds to the closed state). This can suppress the occurrence of distortion due to deformation and improve the durability of the rubber valve 223.

In addition, in the present embodiment, the ratio between the closing stroke of the rubber valve 223 and the opening stroke of the rubber valve 223 is about 1:1. However, if the ratio is within a range of 2:1 to 1:2 (preferably, within a range of 3:2 to 2:3), the effects of the present invention can be expected.

### Further Another Embodiment

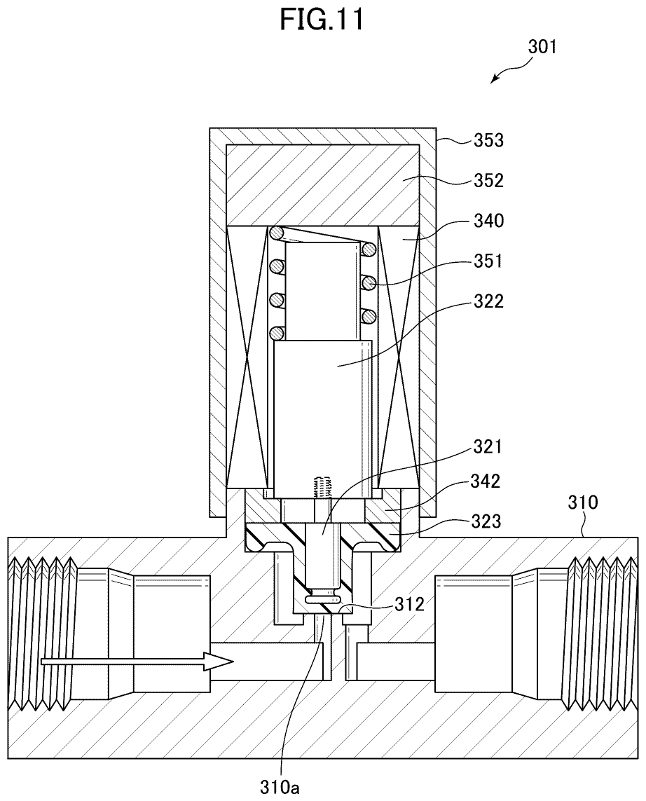

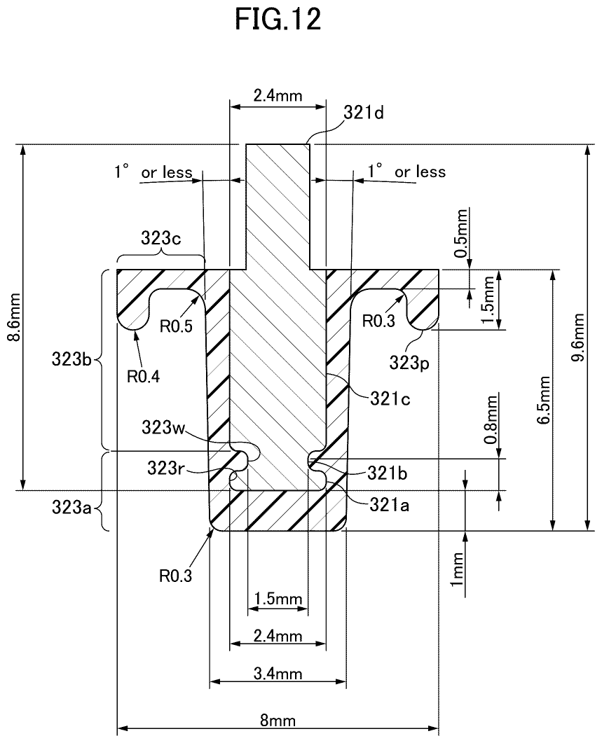

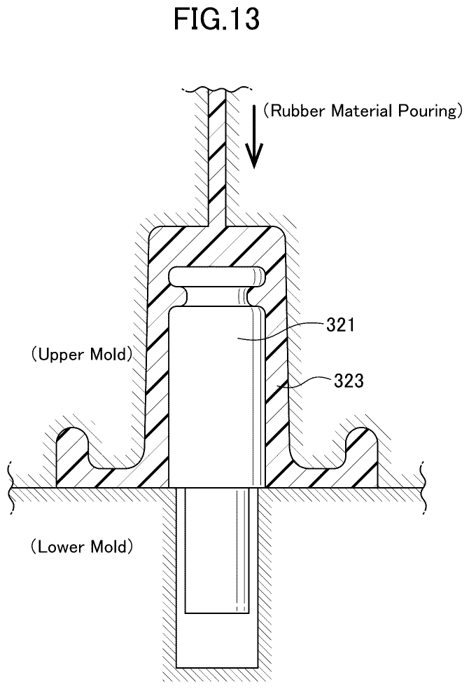

FIG. 11 is a schematic longitudinal sectional view of a rubber valve type of solenoid valve according to further another embodiment of the present invention. FIG. 12 is a longitudinal sectional view of a holding core and a rubber valve of the rubber valve type of solenoid valve. FIG. 13 is a schematic view for explaining a baking process of the rubber valve of the rubber valve type of solenoid valve.

### Structure

As shown in FIG. 11, the rubber valve type of solenoid valve 301 of the present embodiment includes: a main body 310 having a rubber valve seating surface 312 in which one opening 310a is provided; a rubber valve 323 configured to be seated on the rubber valve seating surface 312 of the main body 310; a holding core 321 having one end (a lower end in FIG. 11) which holds the rubber valve 323; and a movable core 322 connected to the other end (an upper end in FIG. 11) of the holding core 321.

The movable core 322 is provided in a movable manner in an axial direction with respect to a fixed core 352 via a coil spring 351 (an example of a biasing member).

The coil spring 351 is configured to apply an elastic force (an example of a biasing force) to the movable core 322 in order to bias the movable core 322 and the holding core 321 with respect to the rubber valve seating surface 312 of the main body 310 such that an opening closure surface portion 323a of the rubber valve 323 abuts against (is seated on) the rubber valve seating surface 312 (a cylindrical portion 323b is deformed in an extended manner: see FIG. 12).

In addition, the rubber valve type of solenoid valve 301 of the present embodiment further includes an electromagnetic force applying part 340 (for example, an electromagnetic coil), which is configured to apply an electromagnetic force to the movable core 322 in order to move the movable core 322 and the holding core 321 with respect to the rubber valve seating surface 312 of the main body 310 such that the rubber valve 323 is moved with respect to the rubber valve seating surface 312. As shown in FIG. 8, the electromagnetic force applying part 340, the fixed core 352 and an upper end of the main body 310 are covered by a cover 353.

Furthermore, the electromagnetic force applying part 340 of the present embodiment is configured to apply an electromagnetic force to the movable core 322 in order to move the movable core 322 and the holding core 321 in a direction away from the rubber valve seating surface 312 of the main body 310 such that the rubber valve 323 is moved away from the rubber valve seating surface 312 (the cylindrical portion 323b is deformed in an shortened manner: see FIG. 12). The movable core 322 of the present embodiment is made of magnetic stainless steel (K-M31).

Herein, at least at the time of filing the present application, the present invention does not exclude another pattern in which the rubber valve 323 is subjected to an elastic force and separated from the rubber valve seating surface 312 before an electromagnetic force is applied to the movable core 322, and the rubber valve 323 abuts against (is seated on) the rubber valve seating surface 312 (the cylindrical portion 323b is deformed in an extended manner) when an electromagnetic force is applied to the movable core 322.

Next, as shown in FIG. 12, the rubber valve 323 of the present embodiment has: the opening closure surface portion 323a; the cylindrical portion 323b which extends from the opening closure surface portion 323a towards the holding core 321; and a flange portion 323c which annularly extends on an outer side than an end of the cylindrical portion 323b on a side of the holding core 321. The rubber valve 323 of the present embodiment is made of EPDM (ethylene propylene diene rubber) and has a hardness of, for example, A70±5.

In addition, as shown in FIG. 12, the holding core 321 has a large diameter end portion 321a at the one end on the side of the opening closure surface portion 323a. Furthermore, the holding core 321 has a small diameter waisted portion 321b (whose inner circumferential surface has a substantially arcuate longitudinal section: see FIG. 12) provided adjacent to the large diameter end portion 321a, a large diameter cylindrical portion 321c (an example of a large diameter columnar portion) provided adjacent to the small diameter waisted portion 321b and extending toward the movable core 322, and a male threaded portion 321d for threadedly engaging with the movable core 322. The male threaded portion 321d can be replaced with any other known connecting element (for example, a mode in which the holding core 321 and the movable core 322 are snap-fitted to each other can also be adopted). The holding core 321 of the present embodiment is made of stainless steel (magnetic properties are not required).

As shown in FIG. 12, the opening closure surface portion 323a of the rubber valve 323 covers the large diameter end portion 321a and the small diameter waisted portion 321b of the holding core 321.

The opening closure surface portion 323a of the rubber valve 323 is fixed by a vulcanized adhesive to an end surface (a lower end surface in FIG. 12) of the large diameter end portion 321a, a circumferential surface of the large diameter end portion 321a, a surface of the small diameter waisted portion 321b on the side of the large diameter end portion 321a (an annular area), and an inner circumferential surface of the small diameter waisted portion 321a (an annular area whose longitudinal section is substantially arcuate). That is to say, the rubber valve 323 is integrally molded with the holding core 321 by a baking process.

For example, the baking process of the rubber valve 323 is carried out using an upper mold and a lower mold, as shown in FIG. 13. By making the size of a hole in the lower mold, into which the male threaded portion 321d is inserted, smaller than the diameter of the large diameter cylindrical portion 321c, the shape of the rubber valve 323 to be molded and the shapes of the molds themselves can be simplified.

In the present embodiment, the vulcanized adhesive is not applied to the lower surface of the large diameter cylindrical portion 321c (the surface of the small diameter waisted portion 321b on the side of the large diameter end portion 321a) adjacent to the inner circumferential surface of the small diameter waisted portion 321b. In this way, the presence of an area where the vulcanized adhesive is not applied prevents the vulcanized adhesive applied to the inner circumferential surface of the small diameter waisted portion 321b from undesirably reaching the circumferential surface of the large diameter cylindrical portion 321c.

As shown in FIG. 11, the movable core 322 has a second cylindrical portion on the side of the fixed core 352, and a first cylindrical portion which forms a step portion between itself and the second cylindrical portion.

As an example of dimensions, the second cylindrical portion has a length of 6.5 mm and a diameter of 5.0 mm, and the first cylindrical portion has a length of 11.0 mm and a diameter of 6.5 mm. In addition, with reference to FIG. 12, the large diameter cylindrical portion 321c has a length of 5.4 mm and a diameter of 2.4 mm, the small diameter waisted portion 321b has a length of 0.6 mm and a minimum diameter of 1.5 mm, and the large diameter end portion 321a has a length of 0.5 mm and a maximum diameter of 2.4 mm.

Returning to FIG. 11, the coil spring 351 has a natural length of 8.8 mm and is inserted between the step portion and the fixed core 352 under a compressed state (in an opening closure state, the length of the coil spring 351 is 8.0 mm). The spring constant of the coil spring 351 is 0.9 N/mm.

Returning to FIG. 12, the outer shape of the opening closure surface portion 323a of the rubber valve 323 has a cylindrical portion with a diameter of 3.4 mm and a height of 2.1 mm, and is provided at an upper center thereof with a large diameter end recess 323r into which the large diameter end portion 321a of the holding core 321 can be fitted, and with a small diameter constricted recess 323w into which the small diameter waisted portion 321b of the holding core 321 can be fitted. The large diameter end recess 323r has a bottom diameter (maximum diameter) of 2.4 mm and a depth of 0.5 mm.

The cylindrical portion 323b of the rubber valve 323 is a circular cylindrical portion having an inner diameter of 2.4 mm, an outer diameter of 3.4 mm, and a length of 5.4 mm, and extends from the upper surface of the opening closure surface portion 323a toward the holding core 321.

The flange portion 323c of the rubber valve 323 extends outward in an annular shape from the end of the cylindrical portion 323b on the side of the holding core 321. The flange portion 323c of the present embodiment has an outer diameter of 8.0 mm and a uniform thickness of 0.5 mm. That is to say, the flange portion 323c of the present embodiment does not have a thinner part. On the other hand, a lower surface of an outer peripheral area of the flange portion 323c is provided with an annular protrusion 323p having a semicircular cross section of R0.4 for fixing to the main body 310. In addition, the lower surface of the flange portion 323c and the protrusion 323p are smoothly continuous (with R) (for example, R0.3).

In addition, as shown in FIG. 11, the main body 310 of the present embodiment is provided with a large diameter hole in which the flange portion 323c of the rubber valve 323 is placed.

As shown in FIG. 11, the flange portion 323c of the rubber valve 323 placed in the large diameter hole is fixed to the main body 310 under a compressed state from above via an annular pressing part (also called an adapter) 342, which has the same outer diameter (8 mm) as the flange portion 323c, and via the electromagnetic force applying part 340. Specifically, an outer area (an area outer than the diameter of 6 mm) of the annular pressing part 342 has a height of 2.0 mm, and the annular protrusion 323p of the flange portion 323c is fixed under a compressed state by 0.3 mm. On the other hand, an inner area (an area inner than the diameter of 6 mm) of the annular pressing part 342 of the present embodiment has a height of 1.4 mm and an inner diameter which is slightly smaller than the outer diameter of the movable core 322, and functions as a stopper that defines a downward movement limit of the movable core 322.

It is preferable that an inner circumferential surface and an upper surface of the annular pressing part 342 are smoothly continuous (with R) (for example, R0.2). Similarly, it is preferable that the inner circumferential surface and a lower surface of the annular pressing part 342 are smoothly continuous (with R) (for example, R0.2).

It is also possible to configure the entire annular pressing part 342 with a flat height without providing a difference in height between the outer area and the inner area of the annular pressing part 342.

A small diameter hole is provided below the large diameter hole to be coaxial with the large diameter hole. An area of the main body 310 on the side of the rubber valve seating surface 312 is formed as an area that protrudes in a cylindrical shape from the bottom surface of the small diameter hole.

Herein, as one feature of the preset embodiment, when neither an electromagnetic force nor an elastic force is applied, i.e., when the rubber valve 323 is in an unloaded state, (the bottom surface of) the opening closure surface portion 323a of the rubber valve 323 is located at a height half the maximum open height from the rubber valve seating surface 312. This feature is an essential feature of the second aspect of the present invention. However, this feature is optional (not essential) for the first aspect of the present invention.

The other structure of the rubber valve type of solenoid valve 301 of the present embodiment is substantially the same as the rubber valve type of solenoid valve 1 explained with reference to FIGS. 1 to 7.

### Operation

Under a state wherein the electromagnetic force applying part 340 is not applying an electromagnetic force to the movable core 322, the movable core 322 and the holding core 321 are biased in a direction approaching the rubber valve seating surface 312 of the main body 310, by an elastic force of the coil spring 351. Thereby, the cylindrical portion 323b of the rubber valve 323 is deformed in an extended manner and a partial area of the flange portion 323c located on the inner side than the pushing part 342 is very slightly deformed as a diaphragm valve, so that the rubber valve 323 is seated on the rubber valve seating surface 312 and the opening closure surface portion 323a closes (seals) the opening 310a.

Based on a controlling instruction from a controller not shown, the electromagnetic force applying part 340 applies an electromagnetic force to the movable core 322. Thereby, the movable core 322 and the holding core 321 are moved in a direction away from the rubber valve seating surface 312 of the main body 310, and thus the rubber valve 323 is moved in the same direction away from the rubber valve seating surface 312. Thereby, the cylindrical portion 323b of the rubber valve 323 is deformed in a shortened manner and the partial area of the flange portion 323c located on the inner side than the pushing part 342 is very slightly deformed as a diaphragm valve, so that the rubber valve 323 is separated from the rubber valve seating surface 312 and the opening 310a is opened.

In the present embodiment, a closing stroke of the cylindrical portion 323b from an unloaded state of the cylindrical portion 323b to a state in which the cylindrical portion 323b is deformed in an extended manner so that the rubber valve 323 is seated on the rubber valve seating surface 312 and the opening closure surface portion 323a closes the opening 310a is about 0.15 mm.

In addition, in the present embodiment, an opening stroke of the cylindrical portion 323b from an unloaded state of the cylindrical portion 323b to a state in which the cylindrical portion 323b is deformed in an shortened manner so that the rubber valve 323 further moves away from the rubber valve seating surface 312 and the opening closure surface portion 323a further opens the opening 310a is about 0.15 mm.

That is to say, in the present embodiment, the ratio between the closing stroke of the cylindrical portion 323b and the opening stroke of the cylindrical portion 323b is about 1:1.

### Effects

According to the rubber valve type of solenoid valve 301 of the present embodiment as described above, since the deformation of the cylindrical portion 323b in an extended and shortened manner is utilized to cause an elastic deformation of the rubber valve 323b, there is no need to provide any thinner part. Therefore, the issue of durability due to the existence of the thinner part can be fundamentally solved.

Specifically, the flange portion 323c of the present embodiment does not have any so-called thinner part and has a thickness of 0.5 mm or more at any position. This feature can achieve very high durability.

In addition, according to the present embodiment, since the opening closure surface portion 323a of the rubber valve 323 and the holding core 321 are fixed to each other with a vulcanized adhesive, the fixing between them is stronger. That is to say, according to the present embodiment, the movable core 322 to which the electromagnetic force is applied and the holding core 321 which holds the rubber valve 323 are separately prepared and connected to each other, and thus the rubber valve 323 can be integrally formed with the holding core 321 by a baking process. For example, a corresponding mold can be prepared, and the rubber valve 323 can be formed around a predetermined portion of the holding core 321 by a baking process, so that the opening closure surface portion 323a of the rubber valve 323 and the holding core 321 can be fixed with a vulcanized adhesive during the baking process.

In addition, according to the present embodiment, the holding core 321 has the large diameter end portion 321a and the small diameter waisted portion 321b at the end portion thereof on the side of the opening closure surface portion 323a, and the opening closure surface portion 323a of the rubber valve 323 has the large diameter end recess 323r and the small diameter constricted recess 323w which respectively cover the large diameter end portion 321a and the small diameter waisted portion 321b of the holding core 321. The engagement relationship brought about by these shapes also effectively prevents undesired detachment between the holding core 321 and the opening closure surface portion 323a of the rubber valve 323.

In addition, according to the present embodiment, the electromagnetic force applying part 340 is configured to apply the electromagnetic force to the movable core 322 in order to move the movable core 322 and the holding core 321 in a direction away from the rubber valve seating surface 312 of the main body 310 such that the rubber valve 323 is moved in the direction away from the rubber valve seating surface 312, and the coil spring 351 is configured to apply the elastic force to the movable core 322 in order to move the movable core 322 and the holding core 321 in a direction approaching the rubber valve seating surface 312 of the main body 310 such that the rubber valve 323 is moved in the direction approaching the rubber valve seating surface 312 under a state wherein the electromagnetic force applying part 340 is not applying the electromagnetic force to the movable core 322.

Furthermore, when only the elastic force is applied (when the electromagnetic force is not applied), the cylindrical portion 323b of the rubber valve 323 is deformed in an extended manner (and a partial area of the flange portion 323c located on the inner side than the pushing part 342 is very slightly deformed as a diaphragm valve), so that the rubber valve 323 is seated on the rubber valve seating surface 312 and the opening closure surface portion 323a closes (seals) the opening 310a. When the electromagnetic force is applied (the elastic force is also applied, but the elastic force is greater than the elastic force), the cylindrical portion 323b of the rubber valve 323 is deformed in a shortened manner (and the partial area of the flange portion 323c located on the inner side than the pushing part 342 is very slightly deformed as a diaphragm valve), so that the rubber valve 323 further moves away from the rubber valve seating surface 312 and the opening closure surface portion 323a further opens the opening 310a.

That is to say, according to the rubber valve type of solenoid valve 301 of the present embodiment, an unloaded state (natural state) of the cylindrical portion 323b does not correspond to either a state in which the opening closure surface portion 323a closes the opening 310a or a state in which the opening closure surface portion 323a is the furthest from the opening 310a, but corresponds to an intermediate state between the above two states. Therefore, the elastic deformation of the cylindrical portion 323b includes both the extended deformation and the shortened deformation, and the maximum deformation value of each of them is suppressed to be smaller than a case in which only the extended deformation occurs (the natural state corresponds to the maximum open state) or a case in which only the shortened deformation occurs (the natural state corresponds to the closed state). This can suppress the occurrence of distortion due to deformation and further improve the durability of the rubber valve 323.

In addition, in the present embodiment, the ratio between the closing stroke of the rubber valve 323 and the opening stroke of the rubber valve 323 is about 1:1. However, if the ratio is within a range of 2:1 to 1:2 (preferably, within a range of 3:2 to 2:3), the effects of the present invention can be expected.

However, this feature is optional (not essential) for the first aspect of the present invention. That is to say, a modified manner wherein an unloaded state (natural state) of the rubber valve corresponds to the state in which the rubber valve closes the opening can also have sufficiently advantageous effects, and another modified manner wherein an unloaded state (natural state) of the rubber valve corresponds to the state in which the rubber valve is the furthest from the opening can also have sufficiently advantageous effects.

Furthermore, according to the rubber valve type of solenoid valve 301 of the present embodiment, the closed state of the opening 310a is maintained by the elastic force of the coil spring 351. Therefore, no power consumption is required in the closed state of the opening 310a. This feature can achieve high energy saving effects.

Specifically, the inventors of the present invention have confirmed that, when an ink intended for commercial-use printers is used as the fluid for the rubber valve type of solenoid valve 301 of the present embodiment and the pressure range applied to the flow channel on the “IN” side is set to −70 to 420 kPa, a flow/a stop of the ink can be controlled smoothly and such controlling performances can have a longer life.

In addition, in the present embodiment as described above, only one opening 310a is provided in the rubber valve seating surface 312, and another opening is provided in the bottom surface of the small diameter hole of the main body 310, but the present invention is not limited to this manner. Another type may be adopted in which two openings are provided in the rubber valve seating surface 312.

In addition, in the present embodiment as described above, the coil spring 351, which is an elastic member, is used as the biasing means. However, instead of this, a mechanism or configuration that applies an air pressure or a liquid pressure to the movable core 322 may be adopted.

In addition, in the present embodiment as described above, the vulcanized adhesive is provided on the end surface of the large diameter end portion 321a, on the circumferential surface of the large diameter end portion 321a, on the surface of the small diameter waisted portion 321b on the side of the large diameter end portion 321a, and on the inner circumferential surface of the small diameter waisted portion 321a. However, another manner wherein the vulcanized adhesive is provided on the end surface of the large diameter end portion 321a, on the circumferential surface of the large diameter end portion 321a and on the surface of the small diameter waisted portion 321b on the side of the large diameter end portion 321a but is not provided on the inner circumferential surface of the small diameter waisted portion 321a is also within the range of the present invention, at least at the time of filing the present application.

Furthermore, further another manner wherein the vulcanized adhesive is provided on the end surface of the large diameter end portion 321a, on the circumferential surface of the large diameter end portion 321a, on the surface of the small diameter waisted portion 321b on the side of the large diameter end portion 321a and on a lower area of the inner circumferential surface of the small diameter waisted portion 321b but is not provided on an upper area of the inner circumferential surface of the small diameter waisted portion 321b is also within the range of the present invention, at least at the time of filing the present application.

Furthermore, yet further another manner wherein the vulcanized adhesive is provided on the end surface of the large diameter end portion 321a, on the circumferential surface of the large diameter end portion 321a, on the surface of the small diameter waisted portion 321b on the side of the large diameter end portion 321a, on the inner circumferential surface of the small diameter waisted portion 321a and on an inner peripheral area of the lower surface of the large diameter cylindrical portion 321c (another part of the small diameter waisted portion 321b) but is not provided on an outer peripheral area of the lower surface of the large diameter cylindrical portion 321c is also within the range of the present invention, at least at the time of filing the present application.

In short, in the present embodiment, it is preferable to interpose an area where the vulcanized adhesive is not applied between the large diameter end portion 321a and the circumferential surface of the large diameter cylindrical portion 321c, in order to prevent the vulcanized adhesive applied on the large diameter end portion 321a from undesirably reaching the circumferential surface of the large diameter cylindrical portion 321c.

### First Modified Example of Embodiment Shown in FIG. 1

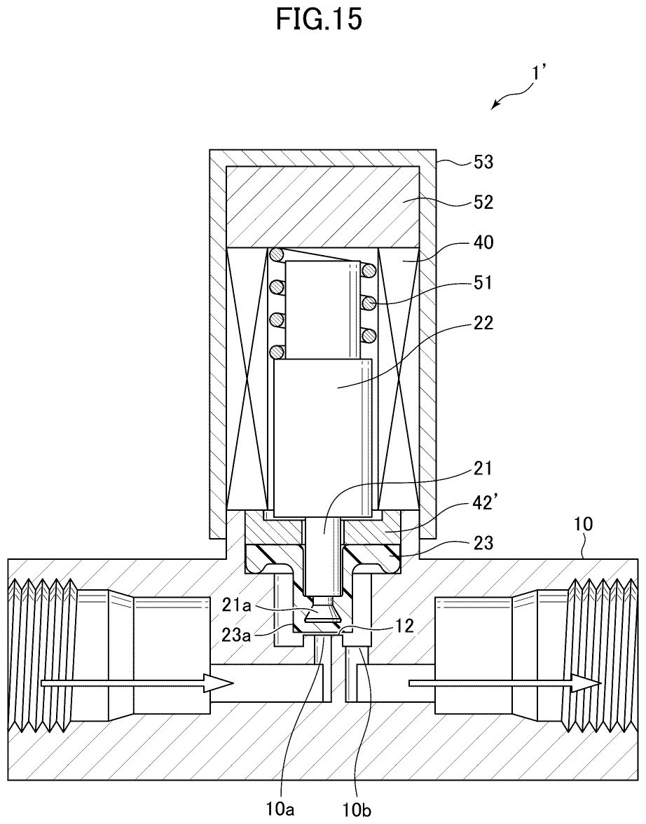

FIG. 15 is a schematic longitudinal sectional view of a rubber valve type of solenoid valve 1′ which is a first modified example of the rubber valve type of solenoid valve 1 shown in FIG. 1. The structure of the rubber valve type of solenoid valve 1′ shown in FIG. 15 is the same as that of the rubber valve type of solenoid valve 1 shown in FIG. 1 except that an inner diameter of a pushing part 42′ differs from the inner diameter of the pushing part 42.

That is to say, in the rubber valve type of solenoid valve 1′ shown in FIG. 15, similarly to the rubber valve type of solenoid valve 1 shown in FIG. 1, the flange portion 23c placed in the large diameter hole 10d is fixed to the main body 10 under a compressed state from above via an annular pressing part (also called an adapter) 42′, which has the same outer diameter (8 mm) as the flange portion 23c, and via the electromagnetic force applying part 40. Specifically, an outer area (an area outer than the diameter of 6 mm) of the annular pressing part 42′ has a height of 2.0 mm, and the annular protrusion 23p of the flange portion 23c is fixed under a compressed state by 0.3 mm. On the other hand, an inner area (an area inner than the diameter of 6 mm) of the annular pressing part 42′ of the present embodiment has a height of 1.4 mm.

Herein, in the rubber valve type of solenoid valve 1′, an inner diameter of the annular pressing part 42′ is 1.9 mm, which is slightly larger than the outer diameter (1.8 mm) of the large diameter cylindrical part 21c of the holding core 21. This feature substantially completely prevents an upward deformation of the flange portion 23c as a diaphragm valve, in addition to functioning as a stopper that defines a downward movement limit of the movable core 22.

According to the present modified example, even if the flange portion 23c is subjected to a high ink pressure from the side of the opening 10a, an upper surface side of the flange portion 23c is supported by the pressing part 42′ and is prevented from undesirably deforming, so that the durability of the flange portion 23c is further improved. As a result, this makes it possible to use a higher ink pressure.

Furthermore, as further modifications of the present modified example, a further modified manner wherein an unloaded state (natural state) of the rubber valve corresponds to a state in which the rubber valve closes the opening can also have sufficiently advantageous effects as one embodiment of the first aspect of the present invention, and another further modified manner wherein an unloaded state (natural state) of the rubber valve corresponds to a state in which the rubber valve is the furthest from the opening can also have sufficiently advantageous effects as one embodiment of the first aspect of the present invention.

### Second Modified Example of Embodiment Shown in FIG. 1

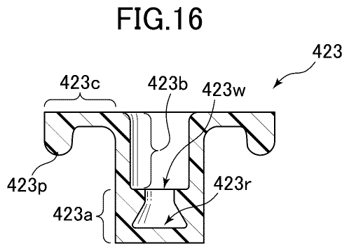

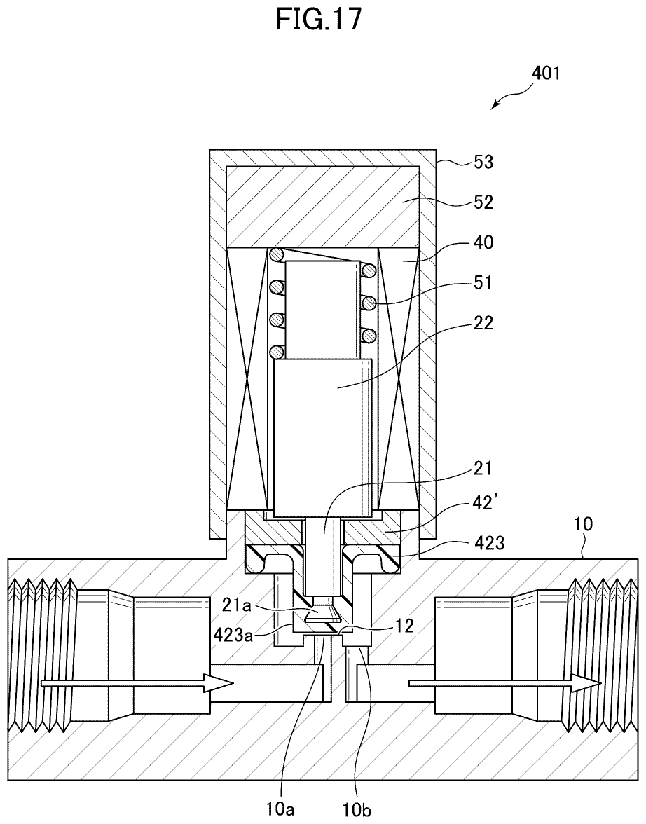

FIG. 16 is a longitudinal sectional view of a rubber valve 423 in a rubber valve type of solenoid valve 401, which is a second modified example of the rubber valve type of solenoid valve 1 shown in FIG. 1. FIG. 17 is a schematic longitudinal sectional view of the rubber valve type of solenoid valve 401. The structure of the rubber valve type of solenoid valve 401 shown in FIG. 17 is the same as that of the rubber valve type of solenoid valve 1′ shown in FIG. 15 except that a thickness of a flange portion 423c of the rubber valve 423 differs from the thickness of the flange portion 23c.

The inventors of the present invention have found that, in the first modified example shown in FIG. 15, when the rubber valve 23 is in contact with the ink (or, in some cases, is immersed in the ink) for a long period of time and the rubber valve 23 reaches a “swollen” state (a physically expanded state in which liquid has penetrated between rubber molecules), a sliding resistance during the extended deformation and the shortened deformation of the cylindrical portion 23b with respect to the holding core 21 becomes excessive, which may cause malfunction (whether or not the “swollen” state is reached depends largely on compatibility between a material of the rubber valve 23 and the ink (type of liquid)).

Then, the inventors of the present invention have also found that it is possible to deal with the issues that may be caused by the “swollen” state by making the thickness of the flange portion 423c of the rubber valve 423 thinner than the thickness (1 mm) of the flange portion 23c. According to the inventors' findings, if the thickness of the flange portion 423c is within a range of 0.4 mm to 0.5 mm, even if the rubber valve 423 reaches the “swollen” state, the degree of physical expansion that inhibits the extended deformation and/or the shortened deformation of the cylindrical portion 23b with respect to the holding core 21 is relatively small, and thus the above-mentioned malfunction does not occur. FIGS. 16 and 17 show an example in which the thickness of the flange portion 423c is 0.4 mm.

As described above, according to the second modified example, even if the flange portion 423c is subjected to a high ink pressure from the side of the opening 10a, an upper surface side of the flange portion 423c is supported by the pressing part 42′ and is prevented from undesirably deforming, so that the durability of the flange portion 423c is further improved. As a result, this makes it possible to use a higher ink pressure. Furthermore, since the thickness of the flange portion 423c is within the range of 0.4 mm to 0.5 mm, even when the “swollen” state is reached, the occurrence of malfunctions can be effectively suppressed.

Furthermore, as further modifications of the second modified example, a further modified manner wherein an unloaded state (natural state) of the rubber valve corresponds to a state in which the rubber valve closes the opening can also have sufficiently advantageous effects as one embodiment of the first aspect of the present invention, and another further modified manner wherein an unloaded state (natural state) of the rubber valve corresponds to a state in which the rubber valve is the furthest from the opening can also have sufficiently advantageous effects as one embodiment of the first aspect of the present invention.

### Third Modified Example of Embodiment Shown in FIG. 1

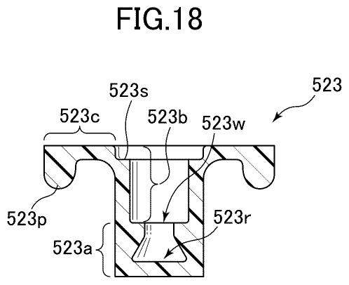

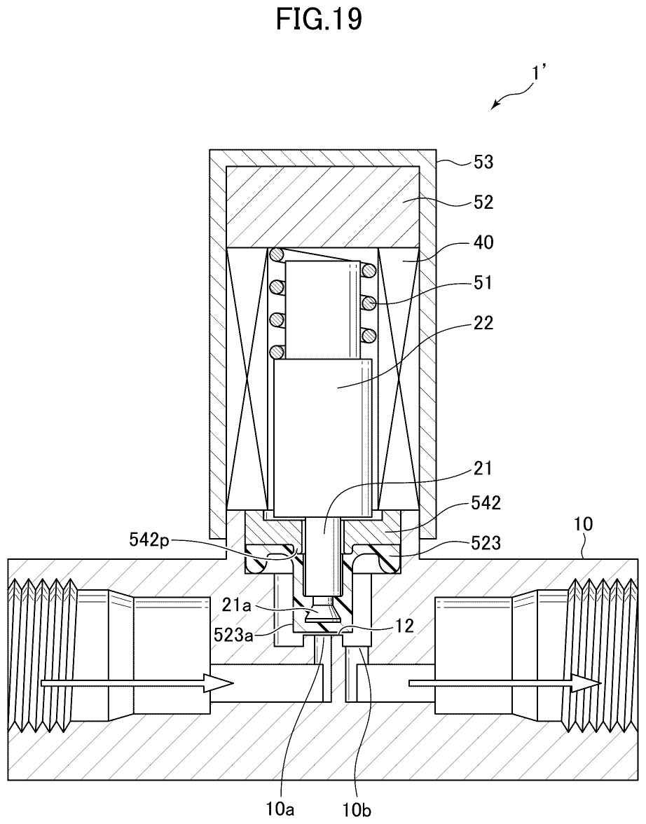

FIG. 18 is a longitudinal sectional view of a rubber valve 523 in a rubber valve type of solenoid valve 501, which is a third modified example of the rubber valve type of solenoid valve 1 shown in FIG. 1. FIG. 19 is a schematic longitudinal sectional view of the rubber valve type of solenoid valve 501. In the rubber valve type of solenoid valve 501 shown in FIG. 19, the rubber valve 523 differs from the rubber valve 23 in that: a flange portion 523c has a thickness of 0.4 mm; an outer surface of a cylindrical portion 523b and a lower surface of the flange portion 523c are smoothly continuous with R0.8; and a step portion 523s is provided at an upper end of the cylindrical portion 523b. In addition, a pushing part 542 differs from the pushing part 42′ in that an annular protrusion 542p protrudes downward from an inner lower surface of the pushing part 524 wherein the step portion 523s and the annular protrusion 542p are fitted to each other. The other structure of the rubber valve type of solenoid valve 501 of the present embodiment is the same as the rubber valve type of solenoid valve 1′ shown in FIG. 15.

For example, the step portion 523s has a radial width of 0.6 mm and a depth of 0.4 mm. Correspondingly to these dimensions, for example, the annular protrusion 542p has a radial width of 0.4 mm and a protrusion height of 0.4 mm. In addition, preferably, a lateral surface of the step portion 523s and a bottom surface of the step portion 523s are smoothly continuous (with R) (for example, R0.2), and an upper surface of the flange portion 523c and the lateral surface of the step portion 523s are also smoothly continuous (with R) (for example, R0.2). Correspondingly to these features, an outer circumferential surface of the annular protrusion 542p and a lower surface of the annular protrusion 542p are also smoothly continuous (with R) (for example, R0.2), and the outer circumferential surface of the annular protrusion 542p and a bottom surface of the pushing part 542 excluding the annular protrusion 542p are smoothly continuous (with R) (for example, R0.2).

Furthermore, it is preferable that an inner circumferential surface of the annular protrusion 542p and the lower surface of the annular protrusion 542p are also smoothly continuous (with R) (for example, R0.2), and that the inner circumferential surface of the annular protrusion 542p and an upper surface of the annular protrusion 542p are also smoothly continuous (with R) (for example, R0.2).

In addition, it is preferable that the difference between the depth of the step portion 523s and the thickness of the flange portion 523c (in particular, the thickness at the thinnest part thereof) is less than 0.1 mm.

It is also possible to configure the entire annular pressing part 542 (excluding the annular protrusion 542p) with a flat height without providing a difference in height between the outer area and the inner area of the annular pressing part 542.

When the rubber valve 523 reaches the “swollen” state, an area around the upper end of the cylindrical portion 523b of the rubber valve 523 is considered more likely to hinder the extended deformation and the shortened deformation of the cylindrical portion 523b with respect to the holding core 21. Therefore, by providing the step portion 523s in advance in this area and further providing the annular protrusion 542p (which is a rigid body) so as to fit into the step portion 523s, the degree of physical expansion that inhibits the extended deformation and/or the shortened deformation of the cylindrical portion 23b with respect to the holding core 21 when the rubber valve 523 reaches the “swollen” state can be suppressed relatively minor, and thus the above-mentioned malfunction does not occur.

As described above, according to the third modified example, even if the flange portion 523c is subjected to a high ink pressure from the side of the opening 10a, an upper surface side of the flange portion 523c is supported by the pressing part 542 and is prevented from undesirably deforming, so that the durability of the flange portion 523c is further improved. As a result, this makes it possible to use a higher ink pressure. Furthermore, the step portion 523s is provided at the upper end of the cylindrical portion 523b of the rubber valve 523, the annular protrusion 542p protrudes downward from the inner lower surface of the pushing part 524, and the step portion 523s and the annular protrusion 542p are fitted to each other. Thereby, even when the “swollen” state is reached, the occurrence of malfunctions can be effectively suppressed.

Furthermore, as further modifications of the third modified example, a further modified manner wherein an unloaded state (natural state) of the rubber valve corresponds to a state in which the rubber valve closes the opening can also have sufficiently advantageous effects as one embodiment of the first aspect of the present invention, and another further modified manner wherein an unloaded state (natural state) of the rubber valve corresponds to a state in which the rubber valve is the furthest from the opening can also have sufficiently advantageous effects as one embodiment of the first aspect of the present invention.

### EXPLANATION OF SIGNS

1 Rubber Valve Type of Solenoid Valve
1′ Rubber Valve Type of Solenoid Valve
10 Main Body
10a Opening
10b Opening
10c Small Diameter Hole
10d Large Diameter Hole
12 Rubber Valve Seating Surface
21 Holding Core
21a Truncated Cone Portion
21b Small Diameter Cylindrical Portion
21c Large Diameter Cylindrical Portion
21d Male Threaded Portion
22 Movable Core
22d First Cylindrical Portion
22e Second Cylindrical Portion
22s Step Portion
23 Rubber Valve
23a Opening Closure Surface Portion
23b Cylindrical Portion
23c Flange Portion
23p Protrusion
23r Truncated Cone Recess
23w Small Diameter Cylindrical Recess
40 Electromagnetic Force Applying Part
42 Pushing Part
42′ Pushing Part
51 Coil Spring
52 Fixed Core
53 Cover
110 Main Body
110a First Flow Channel
110b Second Flow Channel
1110w Partition Wall
112 Diaphragm Seating Surface
122 Diaphragm Boss
122e Small-Diameter Part
122m To-Be-Covered Main Part
123 Diaphragm
123a Thicker Outer Peripheral Part
123b Thinner Part
123c Diaphragm-Boss Covering Part
201 Rubber Valve Type of Solenoid Valve
210 Main Body
210a Opening
212 Rubber Valve Seating Surface
221 Holding Core
222 Movable Core
223 Rubber Valve
240 Electromagnetic Force Applying Part
251 Coil Spring
252 Fixed Core
253 Cover
301 Rubber Valve Type of Solenoid Valve
310 Main Body
310a First Opening
310b Second Opening
310c Small Diameter Hole
312 Rubber Valve Seating Surface
321 Holding Core
321a Large Diameter End Portion
321b Small Diameter Waisted Portion
321c Large Diameter Cylindrical Portion
321d Male Threaded Portion
322 Movable Core
323 Rubber Valve
323a Opening Closure Surface Portion
323b Cylindrical Portion
323c Flange Portion
323p Protrusion
323r Large Diameter End Recess
323w Small Diameter Constricted Recess
340 Electromagnetic Force Applying Part
342 Pushing Part
351 Coil Spring
352 Fixed Core
353 Cover
401 Rubber Valve Type of Solenoid Valve
423 Rubber Valve
423a Opening Closure Surface Portion
423b Cylindrical Portion
423c Flange Portion
423p Protrusion
423r Truncated Cone Recess
423w Small Diameter Cylindrical Recess
501 Rubber Valve Type of Solenoid Valve
523 Rubber Valve
523a Opening Closure Surface Portion
523b Cylindrical Portion
523c Flange Portion
523p Protrusion
523r Truncated Cone Recess
523s Step Portion
523w Small Diameter Cylindrical Recess
542 Pushing Part
542p Annular Protrusion

1. A rubber valve type of solenoid valve comprising:
a main body having a rubber valve seating surface in which at least one flow channel is opened;
a rubber valve configured to be seated on the rubber valve seating surface of the main body;
a holding core having one end which holds the rubber valve;
a movable core connected to the other end of the holding core; and
an electromagnetic force applying part configured to apply an electromagnetic force to the movable core in order to move the movable core and the holding core with respect to the rubber valve seating surface of the main body such that the rubber valve is moved with respect to the rubber valve seating surface;
wherein
the rubber valve has: an opening closure surface portion; a cylindrical portion which extends from the opening closure surface portion towards the holding core; and a flange portion which annularly extends on an outer side than an end of the cylindrical portion on a side of the holding core,
an outer circumferential area of the flange portion is fixed to the main body,
the opening closure surface portion is fixed to the holding core, and
the cylindrical portion is not fixed to the holding core and is capable of being deformed in an extended and shortened manner with respect to the holding core.

2. The rubber valve type of solenoid valve according to claim 1, wherein
the holding core has: a truncated cone portion provided at the one end; a small diameter waisted portion provided adjacent to the truncated cone portion; and a large diameter columnar portion provided adjacent to the small diameter waisted portion and extending toward the movable core, and
the opening closure surface portion of the rubber valve is fixed to at least a part of the truncated cone portion of the holding core with a vulcanized adhesive such that the opening closure surface portion covers the truncated cone portion.

3. The rubber valve type of solenoid valve according to claim 1, wherein
the holding core has: a truncated cone portion provided at the one end; a small diameter waisted portion provided adjacent to the truncated cone portion; and a large diameter columnar portion provided adjacent to the small diameter waisted portion and extending toward the movable core, and
the opening closure surface portion of the rubber valve is fixed to at least a part of the truncated cone portion of the holding core and to at least a part of the small diameter waisted portion of the holding core with a vulcanized adhesive such that the opening closure surface portion covers the truncated cone portion and the small diameter waisted portion.

4. The rubber valve type of solenoid valve according to claim 1, wherein
the holding core has: a large diameter end portion provided at the one end; a small diameter waisted portion provided adjacent to the large diameter end portion; and a large diameter columnar portion provided adjacent to the small diameter waisted portion and extending toward the movable core, and
the opening closure surface portion of the rubber valve is fixed to at least a part of the large diameter end portion of the holding core with a vulcanized adhesive such that the opening closure surface portion covers the large diameter end portion.

5. The rubber valve type of solenoid valve according to claim 1, wherein
the holding core has: a large diameter end portion provided at the one end; a small diameter waisted portion provided adjacent to the large diameter end portion; and a large diameter columnar portion provided adjacent to the small diameter waisted portion and extending toward the movable core, and
the opening closure surface portion of the rubber valve is fixed to at least a part of the large diameter end portion of the holding core and to at least a part of the small diameter waisted portion of the holding core with a vulcanized adhesive such that the opening closure surface portion covers the large diameter end portion and the small diameter waisted portion.

6. The rubber valve type of solenoid valve according to claim 2, wherein
a lubricant is provided between the large diameter columnar portion of the holding core and the cylindrical portion of the rubber valve.

7. The rubber valve type of solenoid valve according to claim 1, wherein
the electromagnetic force applying part is configured to apply the electromagnetic force to the movable core in order to move the movable core and the holding core in one direction with respect to the rubber valve seating surface of the main body such that the rubber valve is moved in the one direction with respect to the rubber valve seating surface,
a biasing member is further provided which is configured to apply a biasing force to the movable core in order to move the movable core and the holding core in the other direction with respect to the rubber valve seating surface of the main body such that the rubber valve is moved in the other direction with respect to the rubber valve seating surface, under a state wherein the electromagnetic force applying part is not applying the electromagnetic force to the movable core,
when the movable core and the holding core are moved in a direction approaching the rubber valve seating surface of the main body by the electromagnetic force or the biasing force, the cylindrical portion of the rubber valve is extended so that the rubber valve is seated on the rubber valve seating surface and the opening closure surface portion closes the opening, and
when the movable core and the holding core are moved in a direction away from the rubber valve seating surface of the main body by the electromagnetic force or the biasing force, the cylindrical portion of the rubber valve is shortened so that the rubber valve further moves away from the rubber valve seating surface and the opening closure surface portion further opens the opening.

8. The rubber valve type of solenoid valve according to claim 7, wherein
a closing stroke of the cylindrical portion from an unloaded state of the cylindrical portion to a state in which the cylindrical portion is extended so that the rubber valve is seated on the rubber valve seating surface and the opening closure surface portion closes the opening, and
an opening stroke of the cylindrical portion from an unloaded state of the cylindrical portion to a state in which the cylindrical portion is shortened so that the rubber valve further moves away from the rubber valve seating surface and the opening closure surface portion further opens the opening,
are within a range of 2:1 to 1:2.

9. The rubber valve type of solenoid valve according to claim 8, wherein
the closing stroke and the opening stroke are within a range of 3:2 to 2:3.

10. (canceled)

11. (canceled)

12. (canceled)

13. The rubber valve type of solenoid valve according to claim 3, wherein
a lubricant is provided between the large diameter columnar portion of the holding core and the cylindrical portion of the rubber valve.

14. The rubber valve type of solenoid valve according to claim 4, wherein
a lubricant is provided between the large diameter columnar portion of the holding core and the cylindrical portion of the rubber valve.

15. The rubber valve type of solenoid valve according to claim 5, wherein
a lubricant is provided between the large diameter columnar portion of the holding core and the cylindrical portion of the rubber valve.
